(19) United States
(12) Patent Application Publication
(10) Pub. No.: US 2015/0368280 A1
(43) Pub. Date: Dec. 24, 2015

(54) HIGH REFRACTIVE INDEX ACRYLIC COMPOUND AND METHOD FOR PREPARING THE SAME

(71) Applicant: SAMSUNG SDI CO., LTD., Yongin-si (KR)

(72) Inventors: Hyun Seok Kim, Uiwang-si (KR); Yong Hee Kang, Uiwang-si (KR); Sun Dae Kim, Uiwang-si (KR); Jin Woo Kim, Uiwang-si (KR)

(21) Appl. No.: 14/748,010

(22) Filed: Jun. 23, 2015

(30) Foreign Application Priority Data
Jun. 23, 2014 (KR) 10-2014-0076807
Jun. 23, 2014 (KR) 10-2014-0076821
Jun. 23, 2014 (KR) 10-2014-0076822

(51) Int. Cl. C07F 9/40; G02B 1/10; G02B 1/04

(52) U.S. Cl. CPC C07F 9/40; G02B 1/04; G02B 1/10

(57) ABSTRACT

An acrylic compound is represented by Formula 1.

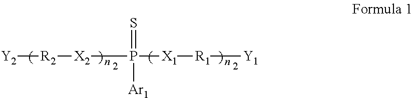

In Formula 1, R₁ and R₂ are each independently a C₂ to C₁₀ alkylene group, a C₆ to C₂₀ arylene group, a C₇ to C₂₀ alkylarylene group, or a C₇ to C₂₀ arylalkylene group. Ar₁ is a C₆ to C₁₀ aryl group. X₁ and X₂ are each independently —O— or —S—. Y₁ and Y₂ are each independently a hydrogen atom, —OH, —SH, —NH₂,

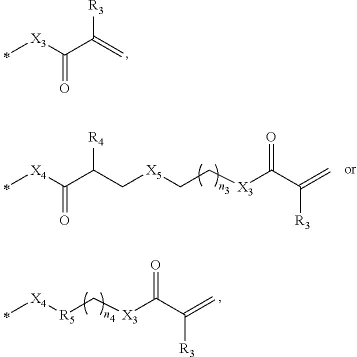

and at least one of Y₁ and Y₂ is

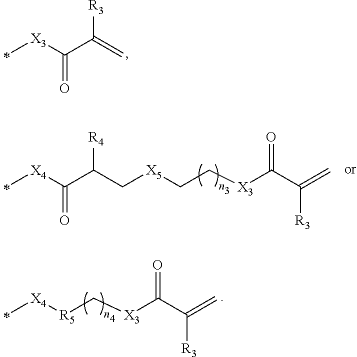

n₁, n₂, n₃ and n₄ are each independently 1 to 4 on average. The acrylic compound includes no halogen atoms and has a high refractive index of about 1.65 or greater.

### CROSS-REFERENCE TO RELATED APPLICATIONS

This application claims priority to and the benefit of Korean Patent Application No. 10-2014-0076807 filed on Jun. 23, 2014, Korean Patent Application No. 10-2014-0076822 filed on Jun. 23, 2014 and Korean Patent Application No. 10-2014-0076821 filed on Jun. 23, 2014, the entire contents of all of which are incorporated herein by reference.

### TECHNICAL FIELD

Embodiments of the present invention relate to high refractive index acrylic compounds, methods for preparing the same, compositions for optical patterns including the same and optical sheet. For example, in some embodiments, a high refractive index acrylic compound has a refractive index of about 1.65 or greater.

### BACKGROUND

Functional materials for manufacturing advanced scientific instruments are being continuously developed. Specifically, high refractive index polymers (HRIP) have drawn much attention due to their potential application in optoelectronic materials, such as substrate materials for display devices, optical adhesives for OLED devices, capsule devices, materials for anti-reflective coatings for optical instruments, optical films, CMOS (complementary metal oxide semiconductor) image sensors (CIS), and the like. Existing polymers have a refractive index (n) ranging from 1.30 to 1.60. However, optoelectronic materials such as polymer microlenses for CMOS image sensors and the like often require a higher refractive index. For example, in high intensity LEDs, a difference in the refractive index (n value) between a semiconductor die (refractive index: 2.50 to 3.50) and a conventional polymer capsule device (refractive index: 1.40 to 1.60) can cause total internal reflection when light passes through the die at a certain angle of incidence to permeate the capsule device, thereby deteriorating light extraction efficiency. In order to address this, it is necessary to reduce the difference in refractive index between the capsule device and the semiconductor die. Since many optoelectronic materials require the use of high refractive index compounds, the design of new high refractive index compounds and synthesis technology is important.

As a method for synthesizing a high refractive index compound, a method of introducing a halogen atom to a compound to enhance polarizability may be employed. However, application of the high refractive index compound including halogen atoms to an optoelectronic material can cause deteriorations in physical properties, such as yellowing, environmental contamination, and the like. Accordingly, a high refractive index compound that does not contain halogen atoms, and which is capable of being used in optoelectronic materials and the like would be desirable.

Further, as the service environment, storage environment and/or manufacturing environment of optical display devices become severe, and as interest in wearable optical display devices increases, various physical properties become desirable. In particular, elastic properties are needed for application to flexible displays.

### SUMMARY

According to embodiments of the present invention, a high refractive index acrylic compound has a refractive index of about 1.65 or greater and contains no halogen atoms. In some embodiments, a method for preparing the high refractive index acrylic compound is provided. In some embodiments, a composition for optical patterns including the high refractive index acrylic compound is provided. In some embodiments an optical sheet comprising optical patterns prepared from the high refractive index acrylic compound is provided.

In some embodiments of the present invention, an acrylic compound is represented by Formula 1:

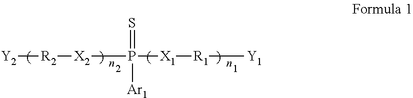

In Formula 1, R₁ and R₂ are each independently a C₂ to C₁₀ alkylene group, a C₆ to C₂₀ arylene group, a C₇ to C₂₀ alkylarylene group, or a C₇ to C₂₀ arylalkylene group. Ar₁ is a C₆ to C₁₀ aryl group. X₁ and X₂ are each independently —O— or —S—. Y₁ and Y₂ are each independently a hydrogen atom, —OH, —SH, —NH₂,

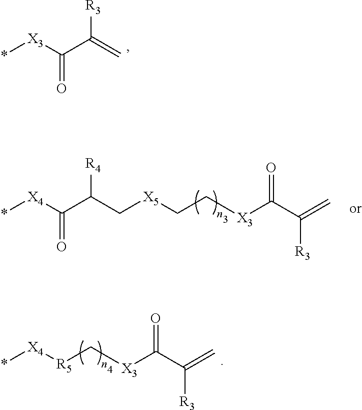

R₃ and R₄ are each independently a hydrogen atom or a methyl group. R₅ is a C₁ to C₁₀ alkylene group, a C₆ to C₂₀ arylene group, a C₆ to C₂₀ arylalkylene group or a C₆ to C₂₀ alkylarylene group. X₃, X₄ and X₅ are each independently —O—, —S— or —N(R)—. R is a hydrogen atom or an alkyl group. * indicates a binding site. At least one of Y₁ and Y₂ is

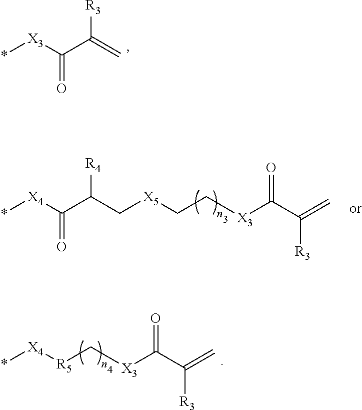

n₁, n₂, n₃ and n₄ are each independently 1 to 4 on average.

In some embodiments, the acrylic compound may include at least one compound selected from compounds represented by Formulae 1a to 1j.

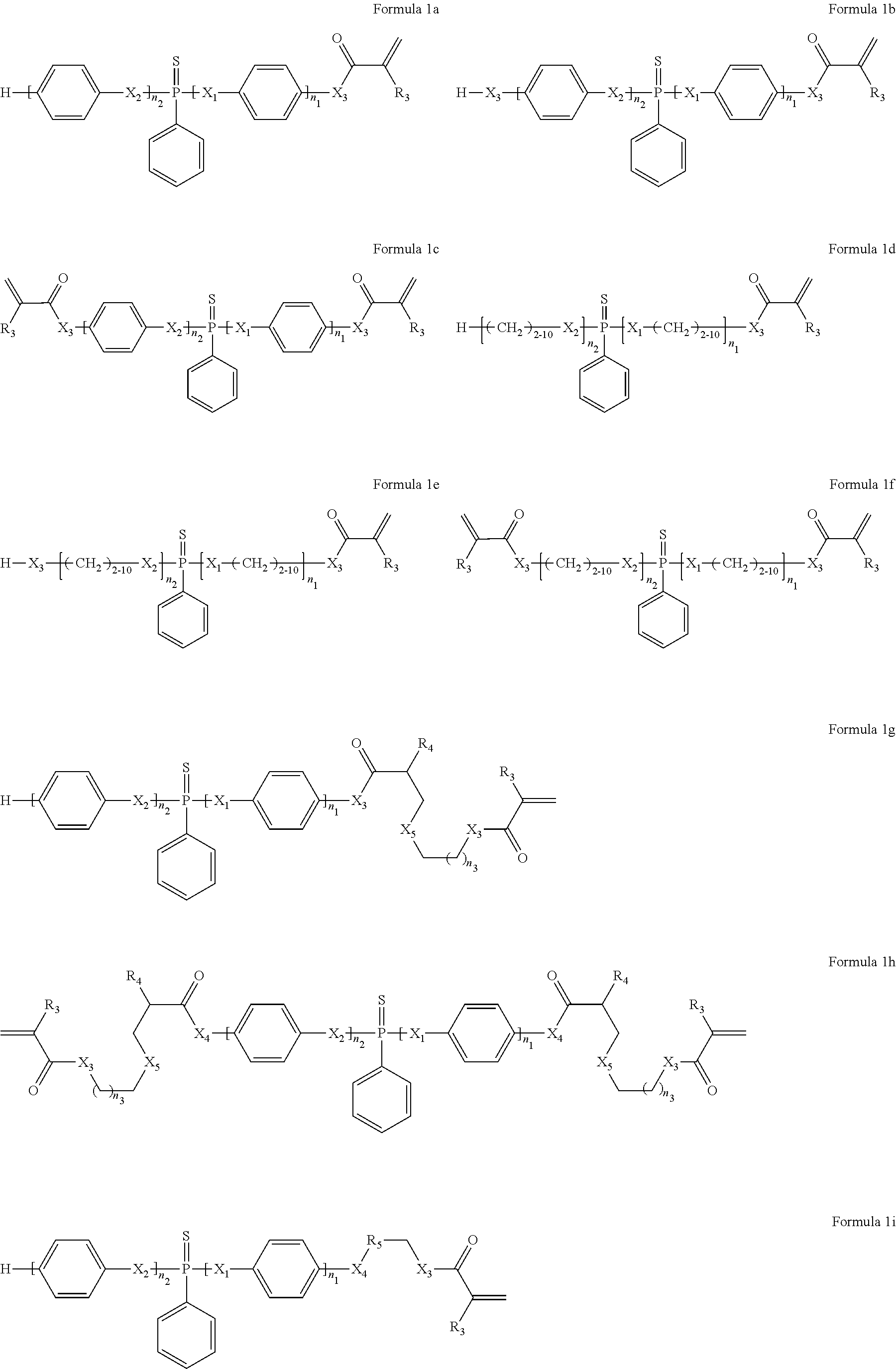

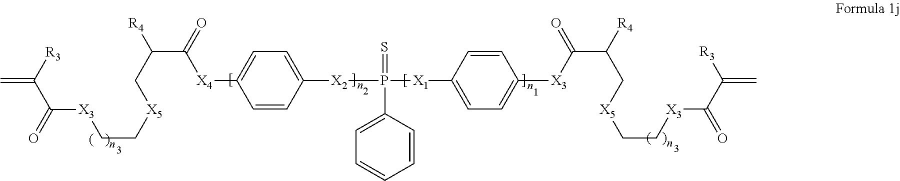

In Formula 1a through 1j, R₃, R₄, R₅, X₁, X₂, X₃, X₄, X₅, n₁, n₂, n₃ and n₄ are as defined in Formula 1.

In some embodiments, the acrylic compound may have a refractive index of about 1.65 to about 1.75.

According to some embodiments of the present invention, a composition for optical patterns includes the acrylic compound. The composition for optical patterns may include the acrylic compound, an initiator, and at least one of a non-phosphorus monomer and a monomer comprising an alkylene oxide unit represented by Formula 7:

*R₁₅—Oₙ* Formula 7

In Formula 7, * indicates a binding site for elements, R₁₅ is a C₁ to C₅ alkylene group, and n is an integer of 1 to 10.

In some embodiments, the composition for optical patterns may further include a crosslinking agent.

In some embodiments, the monomer including the alkylene oxide unit represented by Formula 7 may include a monomer represented by Formula 8:

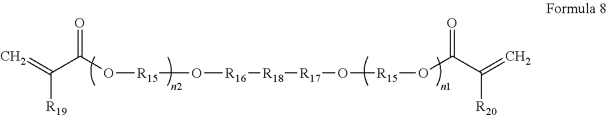

In Formula 8, R₁₆ and R₁₇ are each independently a C₆ to C₁₀ arylene group, a C₇ to C₂₀ alkylarylene group, or a C₇ to C₂₀ arylalkylene group. R₁₈ is a single bond, a C₁ to C₅ alkylene group, —S—, —O—, or —NR (where R may be a hydrogen atom or a C₁ to C₅ alkyl group). R₁₉ and R₂₀ are each independently hydrogen or a methyl group. n₁ and n₂ are each independently an integer of 1 to 10.

In some embodiments, the non-phosphorus monomer may include a mono- or bi-functional (meth)acrylic monomer including a moiety represented by Formulae 6a or 6b, or a mixture thereof.

R₁₁—S—R₁₂—* Formula 6a

In Formula 6a, * indicates a binding site for elements. R₁₁ is a hydrogen atom, a C₁ to C₁₀ alkyl group, a C₆ to C₁₀ aryl group, or a C₇ to C₁₀ arylalkyl group. R₁₂ is a C₁ to C₁₀ alkylene group, a C₆ to C₁₀ arylene group, or a C₇ to C₁₀ arylalkylene group.

*—R₁₃—S—R₁₄—* Formula 6b

In Formula 6b, * indicates a binding site for elements. R₁₃ and R₁₄ are each independently a C₁ to C₁₀ alkylene group, a C₆ to C₁₀ arylene group, or a C₇ to C₁₀ arylalkylene group.

In some embodiments, the crosslinking agent may include a tri- or higher functional (meth)acrylic monomer including an aromatic group.

In some embodiments, the composition may have a drop height of 6 cm or greater at which breakage starts to occur in a ball drop test involving dropping a ball weighing 36 g after the composition is cured.

According to embodiments of the present invention, a method for preparing the acrylic compound includes reacting a sulfur-containing phosphorus compound represented by Formula 2 with an acryloyl halide compound represented by Formula 3.

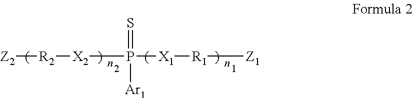

In Formula 2, R₁, R₂, Ar₁, X₁, X₂, n₁ and n₂ are as defined above in connection with Formula 1. Z₁ and Z₂ are each independently a hydrogen atom, —OH, —SH, —NH₂

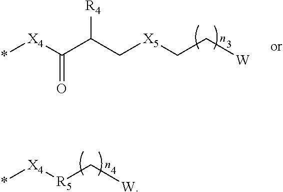

X₄, X₅, R₄, R₅, n₃ and n₄ are as defined above in connection with Formula 1. W is —OH, —SH or —NH₂. At least one of Z₁ and Z₂ is —OH, —SH, —NH₂,

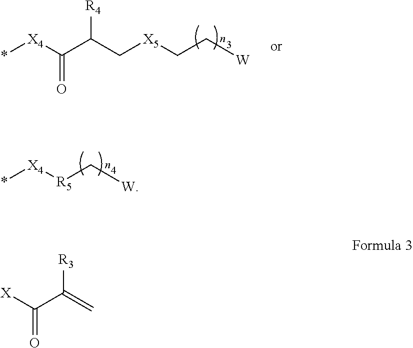

In Formula 3, R₃ is a hydrogen atom or a methyl group and X is a halogen atom.

In some embodiments, the reaction may be performed at about −10° C. to about 10° C. in the presence of a basic catalyst.

In some embodiments, the basic catalyst may include at least one selected from triethylamine, diisopropylamine, tetramethylethylenediamine, pyridine, sodium hydroxide, potassium hydroxide, potassium carbonate, dibutyltin dilaurate, and amine complex compounds.

In some embodiments, the reaction may be performed in a solvent and the solvent may include at least one selected from tetrahydrofuran, chloroform, dichloromethane, N-methylpyrrolidone, methylsulfoxide, N,N-dimethylacetamide, dioxane, alcohol, benzene, dimethoxyethane, acetonitrile, and water.

In some embodiments, the sulfur-containing phosphorus compound may be prepared by reacting a compound represented by Formula 4 with a compound represented by Formula 5a and a compound represented by Formula 5b.

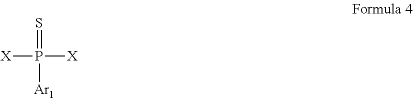

In Formula 4, Ar₁ is as defined above in connection with Formula 1, and X is a halogen atom.

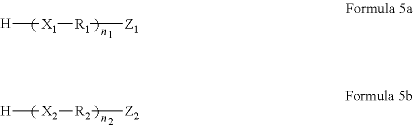

In Formulae 5a and 5b, R₁, R₂, X₁, X₂, n₁ and n₂ are as defined above in connection with Formula 1. Z₁ and Z₂ are each independently a hydrogen atom, —OH, —SH, —NH₂,

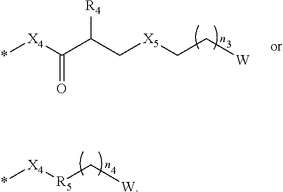

X₄, X₅, R₄, R₅, n₃ and n₄ are as defined above in connection with Formula 1. W is —OH, —SH or —NH₂. At least one of Z₁ and Z₂ is —OH, —SH, —NH₂,

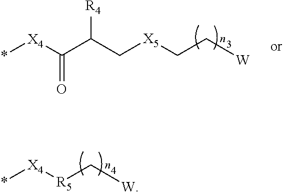

In some embodiments, the sulfur-containing phosphorus compound may be prepared by reacting a compound represented by Formula 4 with a compound represented by Formula 5c and a compound represented by Formula 5d, followed by reaction with a compound represented by Formula 9, and then reacting with a compound represented by Formula 10.

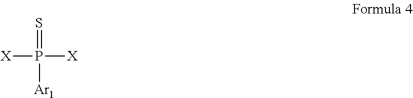

In Formula 4, Ar₁ is as defined above in connection with Formula 1, and X is a halogen atom.

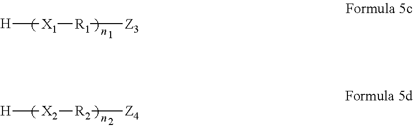

In Formula 5c and 5d, R₁, R₂, X₁, X₂, n₁ and n₂ are as defined above in connection with Formula 1. Z₃ and Z₄ are each independently a hydrogen atom, —OH, —SH or —NH₂. At least one of Z₃ and Z₄ is —OH, —SH, or —NH₂.

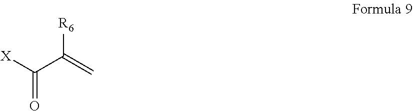

In Formula 9, R₆ is a hydrogen atom or a methyl group, and X is a halogen atom.

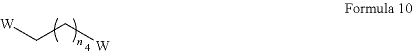

In Formula 10, W is —OH, —SH or —NH₂, and n₄ is 1 to 4 on average.

In some embodiments, the sulfur-containing phosphorus compound may be prepared by reacting a compound represented by Formula 4 with a compound represented by Formula 5c and a compound represented by Formula 5d, followed by reaction with a compound represented by Formula 11.

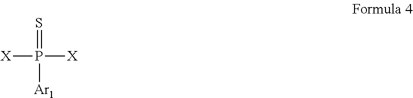

In Formula 4, Ar₁ is as defined above in connection with Formula 1, and X is a halogen atom.

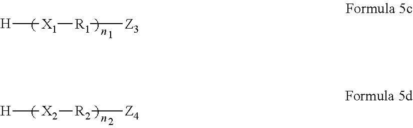

In Formulae 5c and 5d, R₁, R₂, X₁, X₂, n₁ and n₂ are as defined above in connection with Formula 1. Z₃ and Z₄ are each independently a hydrogen atom, —OH, —SH or —NH₂. At least one of Z₃ and Z₄ is —OH, —SH, or —NH₂.

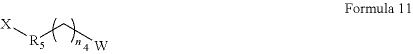

In Formula 11, W is —OH, —SH or —NH₂. R₅ is a C₁ to C₁₀ alkylene group, a C₆ to C₂₀ arylene group, a C₆ to C₂₀ arylalkylene group or a C₆ to C₂₀ alkylarylene group. X is a halogen atom. n₄ is 1 to 4 on average.

According to some embodiments of the present invention, an optical sheet includes a base layer and an optical pattern layer formed on one surface of the base layer, and the optical pattern layer may be formed of the composition for optical patterns described herein.

### BRIEF DESCRIPTION OF THE DRAWINGS

FIG. 1 is a perspective view of an optical sheet according to embodiments of the present invention.

### DETAILED DESCRIPTION

Embodiments of the present invention will be described with reference to the accompanying drawing.

As discussed herein, ball drop testing provides data corresponding to the drop height at which breakage starts to occur when a ball weighing 36 g (SUS, a spherical shape) is dropped from a height of 1 cm. The height from which the ball is dropped is increased after the composition is coated onto one surface of a PET (polyethylene terephthalate) film (T910E, thickness: 75 μm, MITSUBISHI) as a transparent base film, and cured at a fluence of 350 mJ/cm². A higher value indicates better elasticity and impact resistance of the optical sheet.

The acrylic compound according to embodiments of the present invention includes no halogen atoms and is a high refractive index compound having a novel structure and a refractive index of about 1.65 or greater. In some embodiments, the acrylic compound is represented by Formula 1.

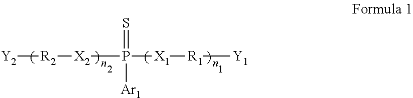

In Formula 1, R₁ and R₂ are each independently a C₂ to C₁₀ alkylene group, a C₆ to C₂₀ arylene group, a C₇ to C₂₀ alkylarylene group, or a C₇ to C₂₀ arylalkylene group. Ar₁ is a C₆ to C₁₀ aryl group. X₁ and X₂ are each independently —O— or —S—. Y₁ and Y₂ are each independently a hydrogen atom, —OH, —SH, —NH₂,

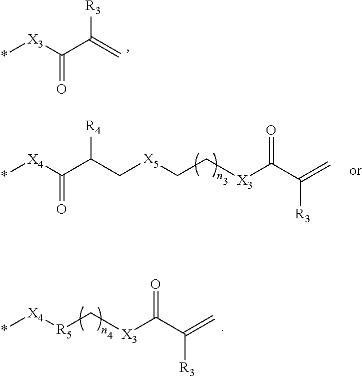

R₃ and R₄ are each independently a hydrogen atom or a methyl group. R₅ is a C₁ to C₁₀ alkylene group, a C₆ to C₂₀ arylene group, a C₆ to C₂₀ arylalkylene group or a C₆ to C₂₀ alkylarylene group. X₃, X₄ and X₅ is —O—, —S— or —N(R)—. R is a hydrogen atom or an alkyl group. * indicates a binding site. At least one of Y₁ and Y₂ is

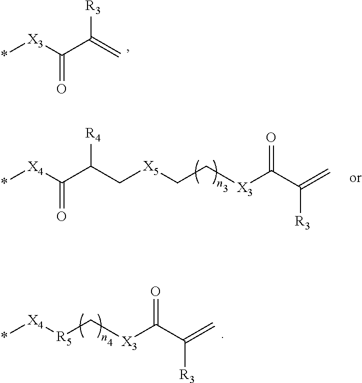

n₁, n₂, n₃ and n₄ are each independently 1 to 4 on average.

In some embodiments, the acrylic compound may include at least one compound selected from compounds represented by Formulas 1a to 1j, but the acrylic compound is not limited thereto. Acrylic compounds represented by Formula 1 (e.g., those represented by Formulae 1a through 1j, below) have high refractive indices, as compared with acrylic compounds having two acrylic functional groups.

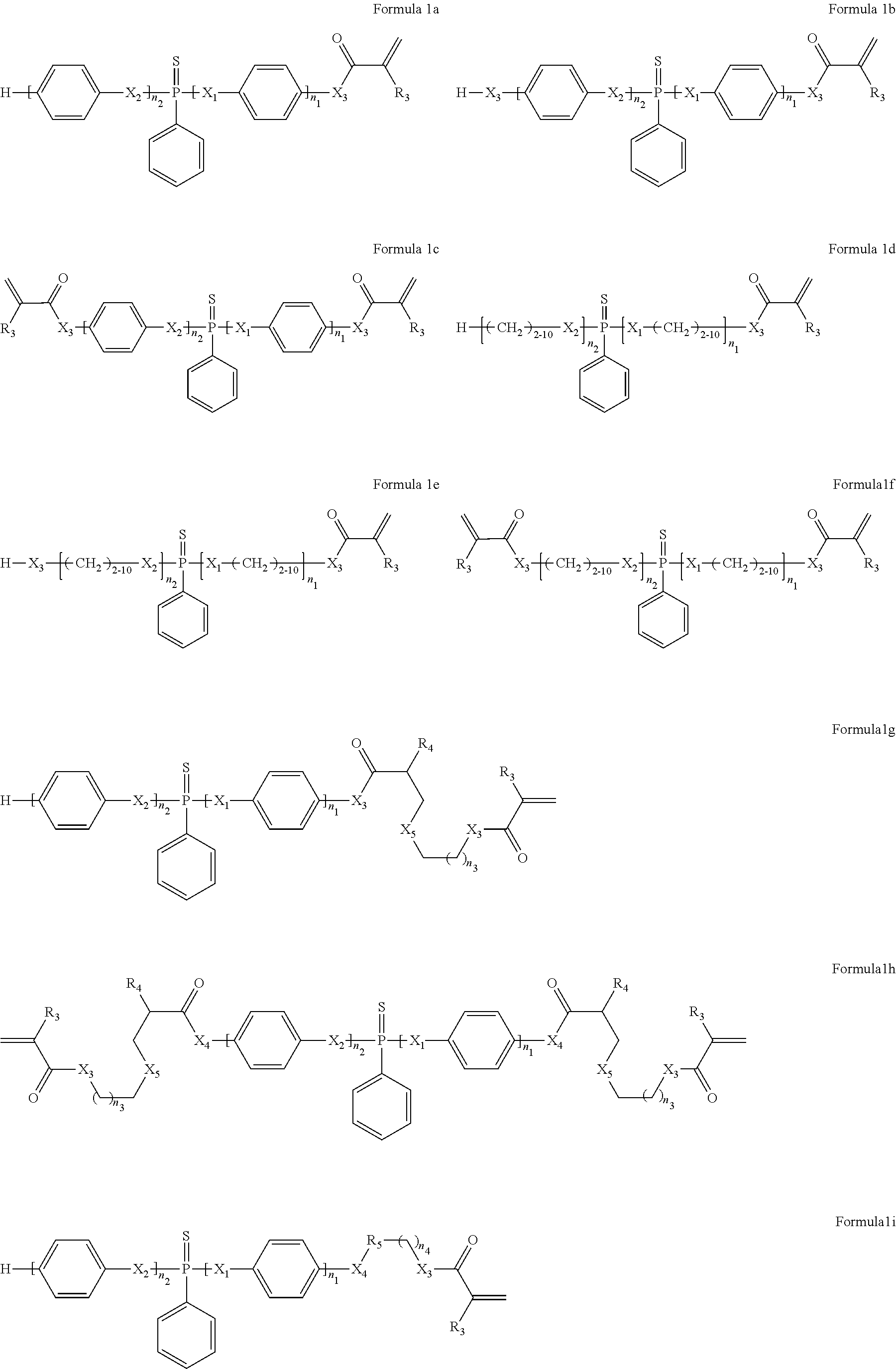

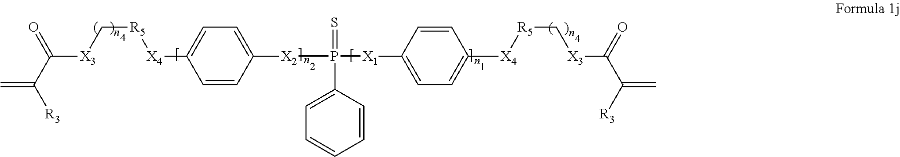

In Formulae 1a through 1j, R₃, R₄, R₅, X₁, X₂, X₃, X₄, X₅, n₁, n₂, n₃ and n₄ are as defined above in connection with Formula 1.

In some embodiments, the acrylic compound according to embodiments of the invention has a refractive index (RI) of about 1.65 or greater, for example, about 1.65 to about 1.75. Within these ranges, it is possible to reduce deteriorations in physical properties (such as light extraction efficiency and yellowing) when the compound is applied to an optoelectronic material or the like.

According to some embodiments of the present invention, a method for preparing the acrylic compound includes reacting a sulfur-containing phosphorus compound represented by Formula 2 with an acryloyl halide compound represented by Formula 3.

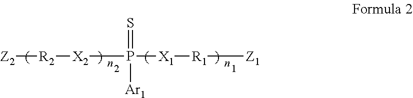

In Formula 2, R₁, R₂, Ar₁, X₁, X₂, n₁ and n₂ are as defined above in connection with Formula 1. Z₁ and Z₂ are each independently a hydrogen atom, —OH, —SH, —NH₂,

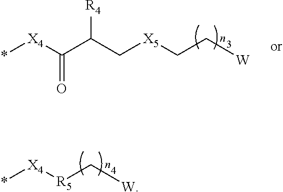

X₄, X₅, R₄, R₅, n₃ and n₄ are as defined above in connection with Formula 1. W is —OH, —SH or —NH₂. At least one of Z₁ and Z₂ is —OH, —SH, —NH₂,

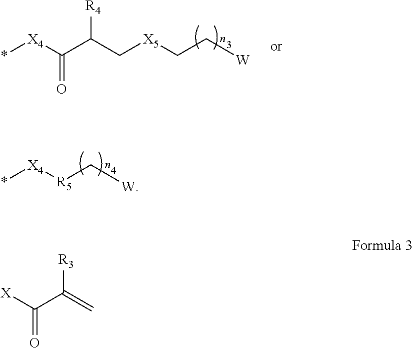

In Formula 3, R₃ is a hydrogen atom or a methyl group, and X is a halogen atom, such as a chlorine atom (Cl), a bromine atom (Br), an iodine atom (I), or the like.

In some embodiments, the reaction is a condensation reaction of the sulfur-containing phosphorus compound and the acryloyl halide compound, in which a hydrogen atom of the terminal —OH, —SH, —NH₂.

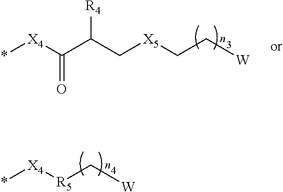

(Z₁ and/or Z₂) moiety in the sulfur-containing phosphorus compound and a halogen atom (X) in the acryloyl halide compound form HX, and the sulfur-containing phosphorus compound and the acryloyl halide compound form an ester, thioester or amide bond. The reaction may be performed in the presence of a basic catalyst at a temperature of about −10° C. to about 10° C., for example, about −5° C. to about 5° C., for about 30 minutes to about 20 hours, for example, about 1 hour to about 10 hours. Within these ranges, it is possible to prepare an acrylic compound with high yield.

In some embodiments, although the molar ratio of the sulfur-containing phosphorus compound to the acryloyl halide compound (sulfur-containing phosphorus compound:acryloyl halide compound) in the reaction may vary depending on the number of (meth)acrylate groups

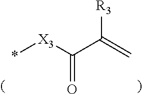

in the acrylic compound, the molar ratio of the sulfur-containing phosphorus compound to the acryloyl halide compound may be, for example, about 1:1 to about 1:2.2.

In some embodiments, the basic catalyst may include triethylamine, tributylamine, diisopropylamine, tetramethylethylenediamine, pyridine, sodium hydroxide, potassium hydroxide, potassium carbonate, dibutyltin dilaurate, an amine complex, or a mixture thereof.

The basic catalyst may be present in an amount of about 100 parts by mole to about 220 parts by mole, for example, about 100 parts by mole to about 150 parts by mole, based on 100 parts by mole of the sulfur-containing phosphorus compound and the acryloyl halide compound. Within these ranges, it is possible to prepare the acrylic compound with high yield.

In some embodiments, the reaction may be performed in a solvent. The solvent may include tetrahydrofuran, chloroform, dichloromethane, N-methylpyrrolidone, dimethylsulfoxide, N,N-dimethylacetamide, dioxane, alcohol, benzene, toluene, dimethoxyethane, acetonitrile, water, or a mixture thereof.

The solvent may be present in an amount of about 300 parts by weight to about 800 parts by weight, for example, about 400 parts by weight to about 500 parts by weight, based on 100 parts by weight of the sulfur-containing phosphorus compound and the acryloyl halide compound. Within these ranges, it is possible to prepare the acrylic compound with high yield, as compared with the used solvent.

In some embodiments, in the

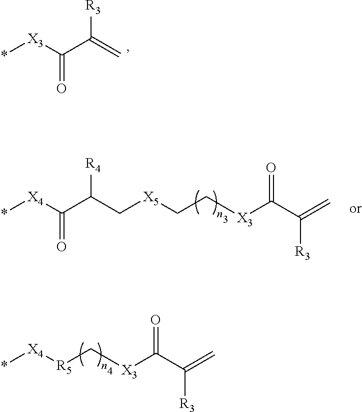

moiety of the acrylic compound represented by Formula 1 (where X₃ is —N(R)— and R is an alkyl group), it is possible to prepare such an acrylic compound using an acrylic compound in which R in —N(R)— is a hydrogen atom, NaH and alkyl iodide, as in Example 5.

In some embodiments, the sulfur-containing phosphorus compound may be prepared by reacting (e.g., via a condensation reaction) a compound represented by Formula 4 with a compound represented by Formula 5a and a compound represented by Formula 5b.

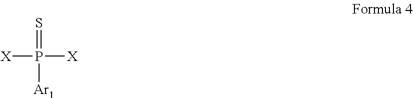

In Formula 4, Ar₁ is as defined above in connection with Formula 1, and X is a halogen atom such as a chlorine atom (Cl), a bromine atom (Br), an iodide atom (I), or the like.

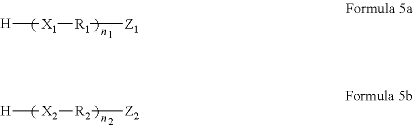

In Formulae 5a and 5b, R₁, R₂, X₁, X₂, n₁ and n₂ are as defined above in connection with Formula 1. Z₁ and Z₂ are each independently a hydrogen atom, —OH, —SH, —NH₂,

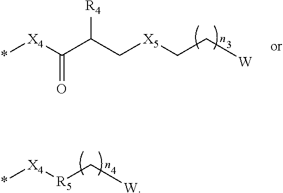

X₄, X₅, R₄, R₅, n₃ and n₄ are as defined above in connection with Formula 1. W is —OH. —SH or —NH₂. At least one of Z₁ and Z₂ is —OH, —SH, —NH₂,

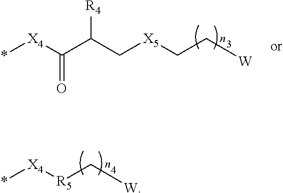

The reaction may be performed in the presence of a basic catalyst at a temperature of about −10° C. to about 50° C., for example, about −5° C. to about 30° C., for about 30 minutes to about 20 hours, for example, about 1 hour to about 10 hours. For example, the compounds represented by Formulae 5a and 5b may be introduced at about −10° C. to about 5° C., and after completing the introduction, the temperature may be adjusted to a temperature of about 5° C. to about 50° C., for example, about 10° C. to about 30° C. Within these ranges, it is possible to prepare the sulfur-containing phosphorus compound with higher yield.

In some embodiments, the molar ratio of the compound represented by Formula 4 to the compounds represented by Formulae 5a and/or 5b (Formula 4:Formula 5a and/or 5b) in the reaction may range from about 1:2 to about 1:2.2, but the molar ratio is not limited thereto.

In some embodiments, the reaction may be performed in the presence of a solvent. As the basic catalyst and solvent, any suitable basic catalyst and solvent may be used, such as those described above in connection with the reaction of the sulfur-containing phosphorus compound and the acryloyl halide compound.

The basic catalyst may be present in an amount of about 100 parts by mole to about 200 parts by mole, for example, about 100 parts by mole to about 150 parts by mole, based on 100 parts by mole of the reactants (compounds of Formulae 4, 5a and/or 5b). Within these ranges, it is possible to prepare the sulfur-containing phosphorus compound with high yield.

Further, the solvent may be present in an amount of about 300 parts by weight to about 800 parts by weight, for example, about 400 parts by weight to about 500 parts by weight, based on 100 parts by weight of the reactants. Within these ranges, it is possible to prepare the sulfur-containing phosphorus compound with high yield, as compared with the solvent used.

In some embodiments, the sulfur-containing phosphorus compound may be prepared by reacting a compound represented by Formula 4 with a compound represented by Formula 5c and a compound represented by Formula 5d, followed by reaction with a compound represented by Formula 9, and then reaction with a compound represented by Formula 10:

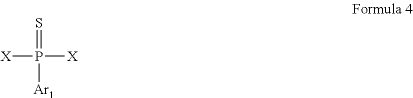

In Formula 4, Ar₁ is as defined above in connection with Formula 1, and X is a halogen atom.

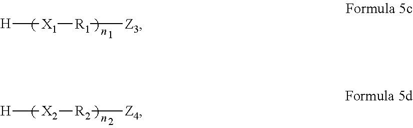

In Formulae 5c and 5d, R₁, R₂, X₁, X₂, n₁ and n₂ are as defined above in connection with Formula 1. Z₃ and Z₄ are each independently a hydrogen atom, —OH, —SH or —NH₂. At least one of Z₃ and Z₄ is —OH, —SH, or —NH₂.

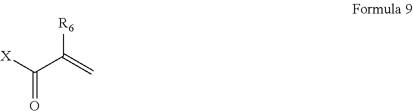

In Formula 9, R₆ is a hydrogen atom or a methyl group, and X is a halogen atom.

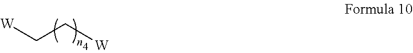

In Formula 10, W is —OH, —SH or —NH₂, and n₄ is 1 to 4 on average.

The reaction of the compound represented by Formula 4 with the compound represented by Formula 5c and/or the compound represented by Formula 5d may be performed in the presence of a basic catalyst at a temperature of about −10° C. to about 50° C., for example, about −5° C. to about 30° C., for about 30 minutes to about 20 hours, for example, about 1 hour to about 10 hours. For example, the compounds represented by Formulae 5c to 5d may be introduced at a temperature of about −10° C. to about 5° C., and after completing the introduction, the temperature may be adjusted to a temperature of about 5° C. to about 50° C., for example, about 10° C. to about 30° C. Within these ranges, it is possible to prepare the sulfur-containing phosphorus compound with higher yield.

In some embodiments, the molar ratio of the compound represented by Formula 4 to the compounds represented by Formulae 5c and/or 5d (Formula 4:Formula 5c and/or 5d) in the reaction may range from about 1:2 to about 1:2.2, but the molar ratio is not limited thereto.

In some embodiments, the reaction of the compound represented by Formula 4 with the compound represented by Formula 5c and/or the compound represented by Formula 5d may be performed in the presence of a solvent. As the basic catalyst and solvent, any suitable basic catalyst and solvent may be used, such as those describe above in connection with the reaction of the sulfur-containing phosphorus compound and acryloyl halide compound.

The basic catalyst may be present in an amount of about 100 parts by mole to about 500 parts by mole, for example, about 100 parts by mole to about 400 parts by mole, based on 100 parts by mole of the reactants (compounds of Formulae 4, 5c and/or 5d). Within these ranges, it is possible to prepare the sulfur-containing phosphorus compound with high yield.

Further, the solvent may be present in an amount of about 300 parts by weight to about 800 parts by weight, for example, about 400 parts by weight to about 500 parts by weight, based on 100 parts by weight of the reactants. Within these ranges, it is possible to prepare the sulfur-containing phosphorus compound with high yield, as compared with the used solvent.

The reaction with the compound represented by Formula 9 may be performed in the presence of a catalyst (such as, e.g., triethylamine, sodium hydroxide, potassium carbonate or sodium carbonate) at a temperature of about −10° C. to about 30° C., for example, about 0° C. to about 5° C., for about 30 minutes to about 3 hours. The molar ratio of the compound represented by Formula 4 to the compound represented by Formula 9 (Formula 4:Formula 9) in the reaction may range from about 1:1 to about 1:2, but is not limited thereto. Further, the reaction may be performed in the presence of a solvent (such as, e.g., tetrahydrofuran (THF), toluene acetone or ethyl acetate). For example, in some embodiments, tetrahydrofuran (THF) may be used.

The catalyst may be present in an amount of about 100 parts by mole to about 400 parts by mole, for example, about 100 parts by mole to about 200 parts by mole, based on 100 parts by mole of the reactants. Within these ranges, it is possible to prepare the sulfur-containing phosphorus compound with high yield.

Further, the solvent may be present in an amount of about 300 parts by weight to about 800 parts by weight, for example, about 400 parts by weight to about 500 parts by weight, based on 100 parts by weight of the reactants. Within these ranges, it is possible to prepare the sulfur-containing phosphorus compound with high yield, as compared with the used solvent.

The reaction with the compound represented by Formula 10 may be performed in the presence of a catalyst (such as, e.g., trimethylamine, sodium hydroxide, potassium carbonate or sodium carbonate) at a temperature of about −10° C. to about 30° C., for example, about 0° C. to about 5° C., for about 30 minutes to about 3 hours. The molar ratio of the compound represented by Formula 4 to the compound represented by Formula 10 (Formula 4:Formula 10) in the reaction may range from about 1:1 to about 1:2, but is not limited thereto. The reaction may be performed in a solvent (such as, e.g., tetrahydrofuran (THF), toluene, acetone or ethyl acetate). For example, in some embodiments, tetrahydrofuran (THF) may be used.

The catalyst may be present in an amount of about 100 parts by mole to about 400 parts by mole, for example, about 100 parts by mole to about 200 parts by mole, based on 100 parts by mole of the reactants. Within these ranges, it is possible to prepare the sulfur-containing phosphorus compound with high yield.

Further, the solvent may be present in an amount of about 300 parts by weight to about 800 parts by weight, for example, about 400 parts by weight to about 500 parts by weight, based on 100 parts by weight of the reactants. Within these ranges, it is possible to prepare the sulfur-containing phosphorus compound with high yield, as compared with the used solvent.

In some embodiments, the sulfur-containing phosphorus compound may be prepared by reacting a compound represented by Formula 4 with a compound represented by Formula 5c and a compound represented by Formula 5d, followed by reaction with a compound represented by Formula 11.

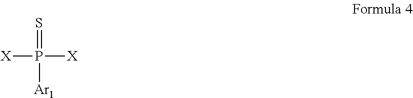

In Formula 4, Ar₁ is as defined above in connection with Formula 1, and X is a halogen atom.

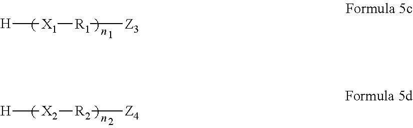

In Formulae 5c and 5d, R₁, R₂, X₁, X₂, n₁ and n₂ are as defined above in connection with Formula 1. Z₃ and Z₄ are each independently a hydrogen atom, —OH, —SH or —NH₂. At least one of Z₃ and Z₄ is —OH, —SH, or —NH₂.

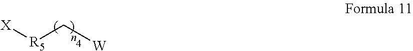

In Formula 11, W is —OH, —SH or —NH₂. R₅ is a C₁ to C₁₀ alkylene group, a C₆ to C₂₀ arylene group, a C₆ to C₂₀ arylalkylene group or a C₆ to C₂₀ alkylarylene group. X is a halogen atom. n₄ is 1 to 4 on average.

The reaction of the compound represented by Formula 4 with the compound represented by Formula 5c and/or the compound represented by Formula 5d may be performed in the presence of a basic catalyst at a temperature of about −10° C. to about 50° C., for example, about −5° C. to about 30° C., for about 30 minutes to about 20 hours, for example, about 1 hour to about 10 hours. For example, in some embodiments, the compounds represented by Formulae 5c to 5d may be introduced at about −10° C. to about 5° C., and after completing the introduction, the temperature may be adjusted to a temperature of about 5° C. to about 50° C., for example, about 10° C. to about 30° C. Within these ranges, it is possible to prepare the sulfur-containing phosphorus compound with higher yield.

The molar ratio of the compound represented by Formula 4 to the compounds represented by Formulae 5c and/or 5d (Formula 4:Formula 5c and/or 5d) in the reaction may range from about 1:2 to about 1:2.2, but is not limited thereto.

The reaction of the compound represented by Formula 4 with the compound represented by Formula 5c and/or the compound represented by Formula 5d may be performed in the presence of a solvent. As the basic catalyst and solvent, any suitable basic catalyst and solvent may be used, such as those described above in connection with reaction of the sulfur-containing phosphorus compound and acryloyl halide compound.

The basic catalyst may be present in an amount of about 100 parts by mole to about 200 parts by mole, for example, about 100 parts by mole to about 150 parts by mole, based on 100 parts by mole of the reactants (compounds of Formulae 4, 5c and/or 5d). Within these ranges, it is possible to prepare the sulfur-containing phosphorus compound with high yield.

Further, the solvent may be present in an amount of about 300 parts by weight to about 800 parts by weight, for example, about 400 parts by weight to about 500 parts by weight, based on 100 parts by weight of the reactants. Within these ranges, it is possible to prepare the sulfur-containing phosphorus compound with high yield, as compared with the used solvent.

The reaction with the compound represented by Formula 11 may be performed in the presence of a catalyst (such as, e.g., triethylamine, sodium hydroxide, potassium carbonate or sodium carbonate) at a temperature of about −10° C. to about 30° C., for example, about 0° C. to about 5° C. for about 30 minutes to about 3 hours. The molar ratio of the compound represented by Formula 4 to the compound represented by Formula 11 (Formula 4:Formula 11) in the reaction may range from about 1:1 to about 1:2, but is not limited thereto. Further, the reaction may be performed in the presence of a solvent (such as, e.g., tetrahydrofuran (THF), toluene, acetone or ethyl acetate). For example, in some embodiments, tetrahydrofuran (THF) may be used.

The catalyst may be present in an amount of about 100 parts by mole to about 400 parts by mole, for example, about 100 parts by mole to about 200 parts by mole, based on 100 parts by mole of the reactants. Within these ranges, it is possible to prepare the sulfur-containing phosphorus compound with high yield.

Further, the solvent may be present in an amount of about 300 parts by weight to about 800 parts by weight, for example, about 400 parts by weight to about 500 parts by weight, based on 100 parts by weight of the reactants. Within these ranges, it is possible to prepare the sulfur-containing phosphorus compound with high yield, as compared with the used solvent.

According to some embodiments of the invention, a composition for optical patterns includes an acrylic compound represented by Formula 1, an initiator, and at least one selected from a monomer including an alkylene oxide unit represented by Formula 7 and a non-phosphorus monomer.

*R₁₅—Oₙ* Formula 7

In Formula 7, * indicates a binding site for elements. R₁₅ is a C1 to C5 alkylene group. n is an integer of 1 to 10. The composition for optical patterns exhibits good impact resistance, scratch resistance, adhesiveness, and refractive index after curing.

The monomer including the alkylene oxide unit of Formula 7 may be a mono- or bi-functional curable monomer, and may be cured together with the acrylic compound of Formula 1. By including the alkylene oxide unit of Formula 7, the cured composition for optical patterns may exhibit further improved scratch resistance.

A single monomer of Formula 7 may be included in the composition for optical patterns, or a combination of two or more monomers represented by Formula 7 may be included.

There is little difference between the refractive index of the monomer including the alkylene oxide unit of Formula 7 and that of the acrylic compound of Formula 1, and when the acrylic compound of Formula 1 is mixed with the monomer including the unit of Formula 7, the cured composition for optical patterns has improved transparency and refractive index. For example, the monomer including the alkylene oxide unit of Formula 7 may have a refractive index of about 1.50 to about 1.56. Within this range, the cured composition for optical patterns can exhibit improved transparency and refractive index. For example, the monomer including the unit of Formula 7 can secure the refractive index by the inclusion of an aromatic group.

In some embodiments, the monomer including the alkylene oxide unit of Formula 7 corresponds to a non-phosphorus monomer (i.e., a monomer that does not include phosphorus) and a non-sulfur monomer (i.e., a monomer that does not include sulfur), and may be represented by Formula 8:

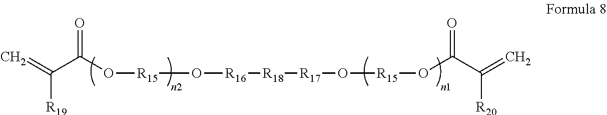

In Formula 8, R₁₆ and R₁₇ are each independently a C₆ to C₁₀ arylene group, a C₇ to C₂₀ alkylarylene group, or a C₇ to C₂₀ arylalkylene group. R₁₈ is a single bond, a C₁ to C₅ alkylene group, —S—, —O—, or —NR (where R is a hydrogen atom or a C₁ to C₅ alkyl group). R₁₉ and R₂₀ are each independently hydrogen or a methyl group. n₁ and n₂ are each independently an integer of 1 to 10.

For example, the monomer of Formula 8 in which R₁₆ and R₁₇ are each independently a C₆ to C₁₀ arylene group and R₁₆ is —S— may have better compatibility with the monomer of Formula 1, which can improve the refractive index of the optical sheet. For example, n₁+n₂ may range from 8 to 14. Within this range, the sheet may have transparency and elasticity. For example, n₁ and n₂ may each independently be 3 to 6.

The monomer including the alkylene oxide unit of Formula 7 may be synthesized in any suitable manner, or a commercially available monomer may be used.

The monomer including the alkylene oxide unit of Formula 7 may be present in an amount of about 25 wt % to about 70 wt %, for example about 30 wt % to about 55 wt % in the composition for optical patterns in terms of solids content. Within these ranges, the composition can exhibit elasticity.

The non-phosphorus monomer can be cured to form a matrix layer and can be used as a dilution monomer to reduce the viscosity of the composition for optical patterns to improve moldability and workability. A mono-functional (meth)acrylic monomer or a bi-functional (meth)acrylic monomer may be included as a non-alkylene oxide-based monomer (i.e., a monomer that does not contain alkylene oxide groups).

There is little difference between the refractive index of the non-phosphorus monomer and that of the acrylic compound of Formula 1, and when the acrylic compound of Formula 1 is mixed with the non-phosphorus monomer, the cured composition for optical patterns has improved transparency and refractive index. For example, in some embodiments, the non-phosphorus monomer may have a refractive index of about 1.55 to about 1.64, for example, about 1.58 to about 1.62. Within these ranges, the cured composition for optical patterns can exhibit improved transparency and refractive index.

The non-phosphorus monomer may include sulfur (S) in order to increase compatibility with the acrylic compound of Formula 1. For example, the non-phosphorus monomer may include a moiety represented by Formulae 6a or 6b.

R₁₁—S—R₁₂—* Formula 6a

In Formula 6a, * indicates a binding site for elements. R₁₁ is a hydrogen atom, a C₁ to C₁₀ alkyl group, a C₆ to C₁₀ aryl group, or a C₇ to C₁₀ arylalkyl group. R₁₂ is a C₁ to C₁₀ alkylene group, a C₆ to C₁₀ arylene group, or a C₇ to C₁₀ arylalkylene group.

*—R₁₃—S—R₁₄—* Formula 6b

In Formula 6b, * indicates a binding site for elements. R₁₃ and R₁₄ are each independently a C₁ to C₁₀ alkylene group, a C₆ to C₁₀ arylene group, or a C₇ to C₁₀ arylalkylene group.

For example, in some embodiments, the non-phosphorus monomer may include at least one selected from a C₆ to C₁₀ arylene group, a C₆ to C₁₀ aryl group, a C₇ to C₁₀ arylalkylene group, and a C₇ to C₁₀ arylalkyl group to increase the refractive index of the monomer and reduce the difference in refractive index from the acrylic compound of Formula 1, thereby enhancing compatibility and transparency of the cured composition for optical patterns.

For example, the non-phosphorus monomer may include at least one selected from [4-(phenylthio)phenyl]alkyl esters including [4-(phenylthio)phenyl]methyl(meth)acrylic ester, and thiobis(1,4-phenylenealkylene)ester including 2-propenoic acid thiobis(1,4-phenylene methylene) ester, but the non-phosphorus monomer is not limited thereto. These monomers may be synthesized, or may be commercially available.

The non-phosphorus monomer may include a single mono-functional (meth)acrylic monomer, or bi-functional (meth)acrylic monomer. However, the use of a mixture of a mono-functional (meth)acrylic monomer and a bi-functional (meth)acrylic monomer can increase the refractive index and crosslinking degree of the cured composition for optical patterns. For example, the mono-functional (meth)acrylic monomer and the bi-functional (meth)acrylic monomer may be mixed in a weight ratio of about 1:1 to about 4:1.

The non-phosphorus monomer may be present in an amount of about 10 wt % to about 70 wt %, for example about 20 wt % to about 60 wt %, in the composition for optical patterns in terms of solids content. Within these ranges, the composition for optical patterns cured together with the acrylic compound of Formula 1 can exhibit increased refractive index and suitable viscosity, thereby improving coating properties.

The initiator serves to cure the acrylic compound of Formula 1, the monomer including the alkylene oxide unit of Formula 7 and/or the non-phosphorus monomer, and may include at least one selected from photocurable initiators, and heat curable initiators. For example, phosphine oxide-based, formate-based, and phosphate-based initiators may be used, but the initiator is not limited thereto.

The initiator may be present in an amount of about 0.1 wt % to about 10 wt %, for example about 1 wt % to about 5 wt % in the composition for optical patterns in terms of solids content. Within these ranges, curing of the composition can be completed, and excess initiator can be prevented from causing yellowing or deteriorations in transparency.

The composition for optical patterns may further include additives, such as, for example, leveling agents, antistatic agents, surfactants, and coloring agents, without being limited thereto. In addition, the composition for optical patterns may be prepared without a solvent (i.e., the composition includes no solvent), or may be prepared with a solvent (i.e., the composition includes a solvent) in order to improve the coating properties of the composition for optical patterns. For example, methylethylketone may be used as the solvent.

The composition for optical patterns according to embodiments of the present invention may exhibit increased elastic properties when including an acrylic compound in which a functional group is linked via an ethylene group, an ethylene group substituted with oxygen (O) or sulfur (S), and the like. For example, the compositions for forming optical patterns including the acrylic compound of Formulae 1g to 1j have a drop height of 6 cm or greater, for example 8 cm or greater, or 10 cm or greater, as measured after cure. As described above, the drop height is defined as the height at which breakage starts to occur when a ball weighing 36 g (SUS, a spherical shape) is dropped from the height. To measure the drop height, the ball is dropped from a height of 1 cm while incremental increases in the height until the breakage is observed. Within these drop height ranges, the optical sheet can exhibit good elastic power and impact resistance.

The composition for optical patterns according to embodiments of the present invention may have a viscosity of about 800 cps to about 2000 cps, for example, about 1000 cps to about 2000 cps, for example, about 800 cps to about 1600 cps at 25° C. Within these ranges, the composition can have improved moldability and workability.

The composition for optical patterns according to embodiments of the present invention may further include a crosslinking agent in order to increase the degree of crosslinking upon curing the composition for optical patterns, thereby enhancing scratch resistance.

The crosslinking agent may be a tri- or higher functional (meth)acrylic monomer. The crosslinking agent may be crosslinked together with the acrylic compound of Formula 1 and the non-phosphorus monomer to increase the degree of crosslinking of the composition for optical patterns, thereby enhancing scratch resistance of the cured composition for optical patterns. The crosslinking agent may be, for example, a tri- to deca-functional, for example, tri- to hepta-functional (meth)acrylic monomer, and a single cross-linking agent may be used or a combination of cross-linking agents may be used.

There is little difference between the refractive index of the crosslinking agent and that of the acrylic compound of Formula 1, and when the acrylic compound of Formula 1 is mixed with the crosslinking agent, the cured composition for optical patterns can have improved transparency and refractive index. For example, in some embodiments, the crosslinking agent has a refractive index of about 1.45 to about 1.55. Within this range, the cured composition for optical patterns can exhibit improved transparency and refractive index.

The crosslinking agent may include 2 to 9 photocurable functional groups (for example, (meth)acrylate groups), at least one of which may have a long-chain structure. A single crosslinking agent may be used or a combination thereof may be used. For example, the crosslinking agent may include an aromatic group, thereby enhancing the refractive index.

The crosslinking agent may be present in an amount of about 0 wt % to about 25 wt %, for example, about 0.1 wt % to about 25 wt % in the composition for optical patterns in terms of solids content. Within these ranges, the composition for optical patterns can have a high degree of crosslinking, and thus, after curing, the composition can have improved scratch resistance, impact resistance and handling properties.

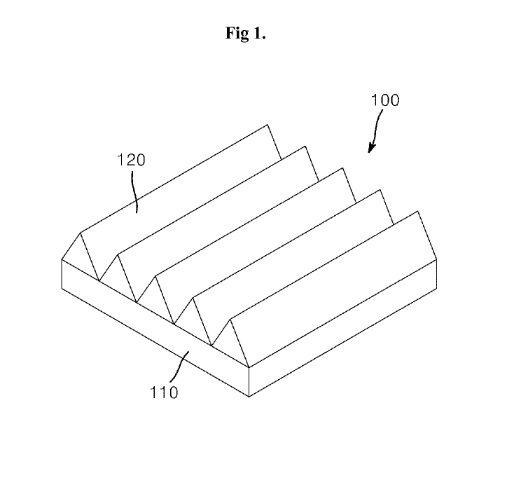

According to some embodiments of the present invention, an optical sheet may include the composition for optical patterns discussed above. Referring to FIG. 1, an optical sheet 100 according to embodiments of the invention includes a base layer 110 and an optical pattern layer 120 formed on one surface of the base layer 110, and the optical pattern layer 120 may be formed of the composition for optical patterns described above.

The optical pattern layer 120 may have a refractive index of about 1.58 or greater, and hmax (maximum indentation depth) of about 5 μm or greater.

The optical sheet 100 may be placed on a light guide plate or other optical sheet in a liquid crystal display, and emits light by refracting light entering from the light guide plate or other optical sheet. The optical sheet 100 according to embodiments of the present invention includes an optical pattern layer 120, which has a refractive index of about 1.58 or greater and a hmax of about 5 μm or greater, thereby emitting incident light with high luminance and improving scratch resistance. For example, the optical pattern layer has a refractive index of about 1.58 to about 1.70 and a hmax of about 5 μm to about 20 μm.

Hereinafter, the present invention will be described with reference to some examples. It should be understood that these examples are provided for illustration only and are not to be construed in any way as limiting the embodiments of the present invention. Descriptions of details apparent to those skilled in the art are omitted herein.

### EXAMPLES

### Preparative Example 1

### Preparation of Compound Represented by Formula 2-1

2.11 g (10 mmol) of phenylenethiophosphonic dichloride was diluted in 30 mL of tetrahydrofuran (THF), and the resultant solution was cooled to 0° C. in an ice bath, followed by adding 1.14 g (11 mmol) of triethylamine. Next, 1.1 g (10 mmol) of thiophenol was diluted in 10 mL of THF, and the resultant solution was slowly added to the above solution using a dropping funnel. With the resultant solution kept at 0° C., 1.14 g (11 mmol) of triethylamine was added to the solution. 1.25 g (10 mmol) of 4-aminobenzenethiol was diluted in 6 mL of THF, and the resultant solution was slowly added to the solution using a dropping funnel. After addition, the ice bath was removed, followed by stirring the solution for about 2 hours. After completion of reaction, the resultant solution was filtered to remove amine salts, followed by distilling under reduced pressure to remove excess solvent. Then, 100 mL of ethyl acetate (EtOAC) was added to the concentrated organic material, which in turn was washed with 80 mL of 5% hydrochloric acid (HCl) and 100 mL of an aqueous sodium hydroxide solution (aq. NaOH, 2M), followed by distillation of the organic layer under reduced pressure. Thereafter, the final compound, namely, a compound represented by Formula 2-1, was separated through column chromatography (SiO₂, ethyl acetate:hexane=1:2) {Colorless oil, yield: 85%, refractive index (RI): 1.73, ¹H-NMR (300 MHz, CDCl₃): δ 7.98-7.90 (m, 2H), 7.51-7.39 (m, 6H), 7.38-7.26 (m, 2H), 7.17-7.13 (m, 2H), 6.59-6.55 (m, 2H)}.

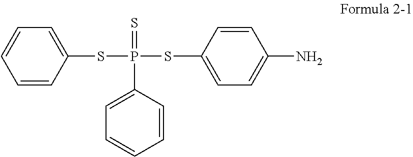 [SMILES: Nc1ccc(SP(=S)(Sc2ccccc2)c2ccccc2)cc1]

### Preparative Example 2

### Preparation of Compound Represented by Formula 2-2

A compound represented by Formula 2-2 was prepared as in Preparative Example 1 except that 1.26 g (10 mmol) of 4-hydroxybenzenethiol was used instead of aminobenzenethiol. The final compound was separated through column chromatography (SiO₂, ethyl acetate:hexane=1:4) {Colorless oil, yield: 72%, refractive index (RI): 1.69, ¹H-NMR (300 MHz, CDCl₃): δ 7.99-7.91 (m, 2H), 7.52-7.35 (m, 6H), 7.31-7.23 (m, 5H), 6.74 (dd, J=1.5, 6.6 Hz, 2H)}.

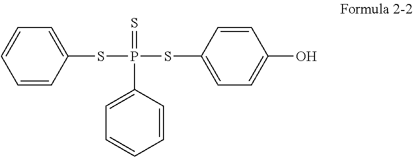 [SMILES: Oc1ccc(SP(=S)(Sc2ccccc2)c2ccccc2)cc1]

### Example 1

### Preparation of Acrylic Compound Represented by Formula 1-1

2.62 g (7.02 mmol) of the compound of Formula 2-1 and 0.71 g (7.02 mmol) of triethylamine were diluted in 20 mL of THF to prepare a diluted solution, which was cooled to 0° C. in an ice bath. Then, a diluted solution prepared by diluting 0.64 g (7.02 mmol) of acryloyl chloride in 8 mL of THF was slowly added to the diluted solution, followed by stirring at 0° C. for 1 hour. After completion of the reaction, the resultant solution was filtered to remove amine salts, and then distilled under reduced pressure to remove excess solvent. Then, 100 mL of ethyl acetate (EtOAC) was added to the concentrated organic material, which in turn was washed with 80 mL of 5% hydrochloric acid (HCl) and 100 mL of an aqueous sodium hydroxide solution (aq. NaOH, 2M), followed by distillation of the organic layer under reduced pressure. Next, the final compound, i.e. the compound represented by Formula 1-1, was separated through column chromatography (SiO₂, ethyl acetate:hexane=1:2) {White solid, yield: 78%, refractive index (RI): 1.72, ¹H-NMR (300 MHz, CDCl₃): δ 7.98-7.93 (m, 2H), 7.53-7.51 (m, 3H), 7.45-7.39 (m, 5H), 7.38-7.25 (m, 5H), 6.42 (dd, J=0.6, 10.2 Hz, 1H), 6.21 (dd, J=6.3, 10.2 Hz, 1H), 5.77 (dd, J=0.6, 6.3 Hz, 1H)}.

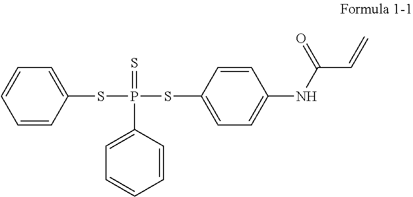 [SMILES: C=CC(=O)Nc1ccc(SP(=S)(Sc2ccccc2)c2ccccc2)cc1]

### Example 2

### Preparation of Acrylic Compound Represented by Formula 1-2

A compound represented by Formula 1-2 was prepared as in Example 1 except that 2.19 g (5.8 mmol) of the compound of Formula 2-2 was used instead of the compound of Formula 2-1. The final compound, i.e. a compound of Formula 1-2, was separated through column chromatography (SiO₂, ethyl acetate:hexane=1:5) {Colorless oil, yield: 78%, refractive index (RI): 1.685, ¹H-NMR (300 MHz, CDCl₃): δ 8.00-7.92 (m, 2H), 7.53-7.32 (m, 10H), 7.09 (dd, J=1.5, 6.6 Hz, 2H), 6.60 (dd, J=1.2, 17.1 Hz, 1H), 6.29 (dd, J=10.5, 17.4 Hz, 1H), 6.02 (dd, J=1.2, 10.5 Hz, 1H)}.

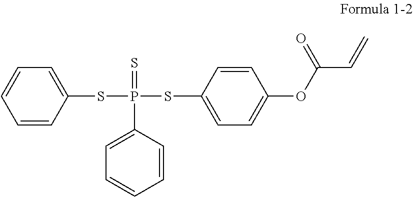 [SMILES: C=CC(=O)Oc1ccc(SP(=S)(Sc2ccccc2)c2ccccc2)cc1]

### Example 3

### Preparation of Acrylic Compound Represented by Formula 1-3

25.04 g (200 mmol) of 4-aminobenzenethiol was diluted in 400 mL of THF to prepare a diluted solution, which in turn was cooled to 0° C. in an ice bath. Then, 21.3 g (210 mmol) of triethylamine was added to the diluted solution. With the resultant solution kept at 0° C., a diluted solution prepared by diluting 21.1 g (100 mmol) of phenylenethiophosphonic dichloride in 200 mL of THF was slowly added to the solution using a dropping funnel. After completion of the addition, the ice bath was removed and the resultant solution was stirred for 2 hours. After completion of the reaction, the resultant solution was filtered to remove amine salts and cooled to 0° C. Then, 21.3 g (210 mmol) of trimethylamine was added to the resultant solution and a diluted solution prepared by diluting 18.6 g (205 mmol) of acryloyl chloride in 100 mL of THF was further slowly added thereto, followed by stirring at 0° C. for 1 hour. After completion of the reaction, the resultant solution was filtered to remove amine salts and distilled under reduced pressure to remove excess solvent. Then, 500 mL of ethyl acetate (EtOAC) was added to the concentrated organic material, which in turn was washed with 200 mL of 5% hydrochloric acid (HCl) and 300 mL of an aqueous sodium hydroxide solution (aq. NaOH, 2M), followed by distillation of the organic layer under reduced pressure. Thereafter, the final compound, i.e. the compound of Formula 1-3, was separated through column chromatography (SiO₂, ethyl acetate:hexane=2:1) {White solid, yield: 64%, refractive index (RI): 1.696, ¹H-NMR (300 MHz, CDCl₃): δ 7.98-7.95 (m, 2H), 7.53-7.44 (m, 9H), 7.34-7.25 (m, 4H), 6.41 (dd, J=0.9, 10.2 Hz, 1H), 6.23 (dd, J=6.0, 9.9 Hz, 1H), 5.77 (dd, J=0.6, 6.0 Hz, 1H)}.

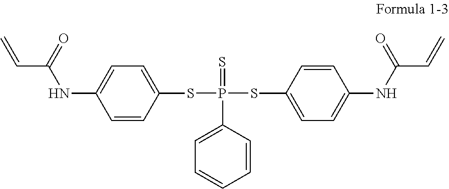 [SMILES: C=CC(=O)Nc1ccc(SP(=S)(Sc2ccc(NC(=O)C=C)cc2)c2ccccc2)cc1]

### Example 4

### Preparation of Acrylic Compound Represented by Formula 1-4

A compound represented by Formula 1-4 was prepared as in Example 3 except that 25.23 g (200 mmol) of 4-hydroxybenzenethiol was used instead of 4-aminobenzenethiol. The final compound, i.e. a compound of Formula 1-4, was separated through column chromatography (SiO₂, ethyl acetate:hexane=1/2) {Colorless oil, yield: 82%, refractive index (RI): 1.657, ¹H-NMR (300 MHz, CDCl₃): δ 7.95-7.93 (m, 2H), 7.53-7.51 (m, 1H), 7.47-7.40 (m, 6H), 7.10 dd, J=1.8, 6.9 Hz, 4H), 6.59 (dd, J=0.6, 10.2 Hz, 1H), 6.29 (dd, J=6.3, 10.2 Hz, 1H), 6.01 (dd, J=0.6, 6.0 Hz, 1H)}.

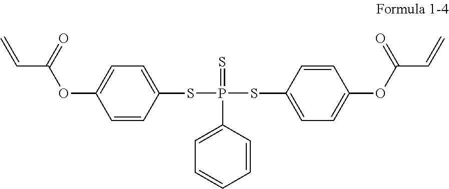 [SMILES: C=CC(=O)Oc1ccc(SP(=S)(Sc2ccc(OC(=O)C=C)cc2)c2ccccc2)cc1]

### Example 5

### Preparation of Acrylic Compound Represented by Formula 1-5

0.18 g (0.37 mmol) of the acrylic compound of Formula 1-3 was diluted in dimethylformamide (DMF) and cooled to 0° C. Then, 184 mg (1.6 mmol) of NaH was added to the solution, which in turn was stirred for 30 minutes. After stirring, 227 mg (1.6 mmol) of methyl iodide was added to the resultant solution, which in turn was stirred at room temperature for 10 hours to prepare an acrylic compound represented by Formula 1-5. The final compound was separated through column chromatography (SiO₂, ethyl acetate:hexane=2:1) {White solid, yield: 82%, refractive index (RI): 1.658, ¹H-NMR (300 MHz, CDCl₃): δ 8.03-7.98 (m, 2H), 7.56-7.48 (m, 7H), 7.12-7.08 (m, 4H), 6.38 (dd, J=0.9, 10.2 Hz, 1H), 6.03 (dd, J=6.0, 9.9 Hz, 1H), 5.55 (dd, J=0.6, 6.0 Hz, 1H), 3.34 (s, 6H)}.

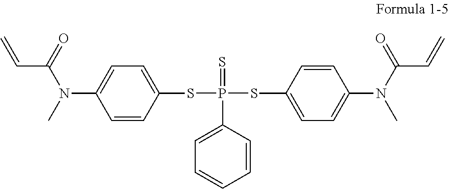 [SMILES: C=CC(=O)N(C)c1ccc(SP(=S)(Sc2ccc(N(C)C(=O)C=C)cc2)c2ccccc2)cc1]

### Examples 6 to 9

### Preparation of Acrylic Compounds Represented by Formulae 1-6 through 1-9

The acrylic compounds represented by Formulae 1-6, 1-7, 1-8 and 1-9 were prepared in a manner similar to that described in Example 1. Each of the compounds was found to have a refractive index within the range of 1.65 to 1.75.

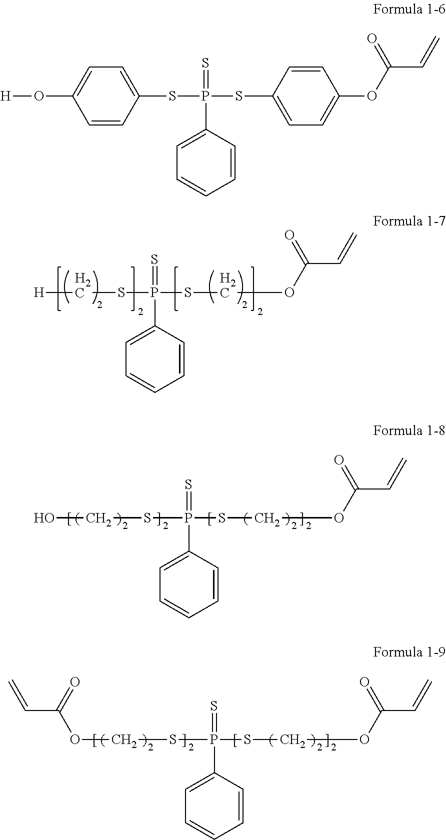

### Example 10

### Preparation of Acrylic Compound Represented by Formula 1-10

A diluted solution was obtained by diluting 42.22 g (200 mmol) of phenylthiophosphonic dichloride and 22.04 g (190 mmol) of thiophenol in 500 mL toluene, and cooled in an ice bath. To the resultant solution, a diluted solution prepared by diluting 20.44 g (202 mmol) of triethylamine in 100 mL toluene was slowly added dropwise. The resultant solution was stirred for 1 hour while maintaining the temperature of the resultant solution at 0° C. Then, 23.78 g (190 mmol) of 4-aminobenzenethiol was added to the resultant solution, and a diluted solution prepared by diluting 20.44 g (202 mmol) of trimethylamine in 100 mL toluene was slowly added dropwise to the resultant solution. After completion of the reaction, the resultant solution was filtered to remove triethylamine salts. After the filtered organic solution was cooled to 0° C., 30 mL of 5% aq hydrochloric acid (HCl) was added to the resultant solution to form aniline salts, which were filtered as intermediates (white solid, quantitative yield). Then, 500 mL of CH₂Cl₂ was added to the obtained aniline salts, which in turn was cooled to 0° C., and then a diluted solution prepared by diluting 12 g (300 mmol) of sodium hydroxide (NaOH) in 15 g of water was slowly added dropwise to the resultant solution. Thereafter, a diluted solution prepared by diluting 18.1 g (200 mmol) of acryloyl chloride in 100 mL of CH₂Cl₂ was added slowly to the resultant solution, which in turn was stirred for 1 hour. After completion of the reaction, the reaction product was washed with aq. 5% HCl/aq. 5% NaOH, and the organic layer was extracted with CH₂Cl₂, dried with magnesium sulfate (MgSO₄) and filtered to obtain an organic solution layer. 19.3 g (190 mmol) of triethylamine was added to the organic solution layer, which in turn was cooled again to 0° C. To the cooled reactant, 14.8 g (190 mmol) of mercaptoethanol was slowly added dropwise and reacted at room temperature for 2 hours. After completion of the reaction, the obtained product was washed with aq. 5% NaOH/aq. 5% NaCl, and the organic layer was extracted with CH₂Cl₂, dried with magnesium sulfate (MgSO₄) and filtered to obtain an organic solution layer. 19.3 g (190 mmol) of triethylamine was added to the organic solution layer, which in turn was cooled again to 0° C. To the cooled reactant, a diluted solution prepared by diluting 18.1 g (200 mmol) of acryloyl chloride in 100 mL of CH₂Cl₂ was slowly added and stirred for 1 hour. After completion of the reaction, the reaction product was washed with aq. 5% HCl/aq. 5% NaOH, and the organic layer was extracted with CH₂Cl₂, dried with magnesium sulfate (MgSO₄) and distilled under reduced pressure to prepare the final product {Pale yellow sticky oil, yield: 81%, refractive index (RI)=1.656}. ¹H-NMR (300 MHz, CDCl₃): δ 7.83-7.78 (m, 2H), 7.38-7.36 (m, 3H), 7.31-7.25 (m, 5H), 7.23-7.11 (m, 5H), 6.36 (dd, J=0.6, 10.2 Hz, 1H), 6.07 (dd, J=6.3, 10.2 Hz, 1H), 5.61 (dd, J=0.6, 6.3 Hz, 1H), 4.33 (t, J=6.8 Hz, 2H), 2.99-2.76 (m, 6H).

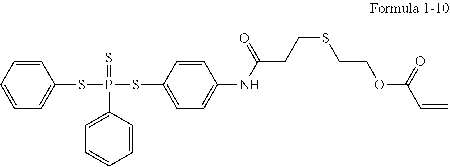 [SMILES: C=CC(=O)OCCSCCC(=O)Nc1ccc(SP(=S)(Sc2ccccc2)c2ccccc2)cc1]

A composition prepared by mixing 25 parts by weight of the compound represented by Formula 1-10, 45 parts by weight of TBP-102 (refractive index: 1.553, Hannong Chemical Co., Ltd.), 24 parts by weight of HRI-84 (refractive index: 1.602, Daerim Chemical Co., Ltd.), 3 parts by weight of PN662NT (refractive index: 1.503, Miwon Special Chemical Co., Ltd.) as a crosslinking agent, and 3 parts by weight of TPO (refractive index: 1.6, BASF AG) as an initiator was coated onto one surface of a transparent PET (polyethylene terephthalate) base film (T910E, thickness: 75 μm, Mitsubishi), cured at 350 mJ/cm² and then subjected to ball drop testing, which yielded a drop height of 10 cm.

### Example 11

### Preparation of Acrylic Compound Represented by Formula 1-11

A diluted solution was obtained by diluting 42.22 g (200 mmol) of phenylthiophosphonic dichloride and 22.04 g (200 mmol) of thiophenol in 500 mL toluene and cooling the solution in an ice bath. To the resultant solution, a diluted solution prepared by diluting 20.44 g (202 mmol) of triethylamine in 100 mL toluene was slowly added dropwise. The resultant solution was stirred for 1 hour while maintaining the temperature of the resultant solution at 0° C. Then, 25.24 g (200 mmol) of 4-hydroxybenzenethiol was added to the resultant solution, and a diluted solution prepared by diluting 20.44 g (202 mmol) of triethylamine in 100 mL toluene was slowly added dropwise to the resultant solution. After completion of the reaction, the resultant solution was filtered to remove triethylamine salts, and the filtered organic solution was cooled to 0° C., followed by removing the remaining triethylamine using aq. 3% HCl/aq. 3% NaCl. A layer-separated organic layer was cooled to −5° C., followed by adding 25% NaOH to yield a white emulsion precipitate (sodium phenolate product intermediate) on the bottom, which was decanted to remove toluene supernatant. To the white solid compound remaining in the reaction vessel, 500 mL toluene was added, and the organic layer was extracted through desalting with aq. 10% HCl. To the extracted toluene organic layer, 20.44 g (202 mmol) of triethylamine was added, and then a diluted solution prepared by diluting 18.1 g (200 mmol) of acryloyl chloride cooled to 0° C. in 100 mL toluene was slowly added and stirred for 1 hour. After completion of the reaction, the obtained product was washed with aq. 5% HCl/aq. 5% NaOH, and the organic layer was extracted with toluene, dried with MgSO₄, and filtered to prepare an organic solution layer. Then, 20.44 g (202 mmol) of triethylamine was added to the organic solution layer, which in turn was cooled again to 0° C. To the cooled reactant, 15.63 g (200 mmol) of mercaptoethanol was slowly added dropwise and reacted at room temperature for 1 hour. After completion of the reaction, the reaction product was washed with aq. 5% NaOH/aq. 5% NaCl, and the organic layer was extracted with 200 mL of ethyl acetate (EtOAc), dried with MgSO₄, and filtered to prepare an organic solution layer. Then, 20.44 g (200 mmol) of triethylamine was added to the organic solution layer, which in turn was cooled again to 0° C. To the cooled reactant, a diluted solution prepared by diluting 18.1 g (200 mmol) of acryloyl chloride in 100 mL toluene was slowly added and stirred for 1 hour. After completion of the reaction, the reaction product was washed with aq. 5% NaOH/aq. 5% NaCl, and the organic layer was extracted with CH₂Cl₂, dried with MgSO₄ and distilled under reduced pressure to prepare the final product {Pale yellow sticky oil, yield: 72%, refractive index (RI)=1.651}. ¹H-NMR (300 MHz, CDCl₃): δ 8.00-7.92 (m, 2H), 7.49-7.26 (m, 10H), 7.09 (dd, J=1.5, 6.6 Hz, 2H), 6.42 (dd, J=1.2, 17.1 Hz, 1H), 6.12 (dd, J=10.5, 17.4 Hz, 1H), 5.84 (dd, J=1.2, 10.5 Hz, 1H), 4.32 (t, J=6.8 Hz, 2H), 2.98-2.76 (m, 6H).

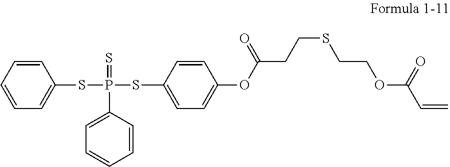 [SMILES: C=CC(=O)OCCSCCC(=O)Oc1ccc(SP(=S)(Sc2ccccc2)c2ccccc2)cc1]

A composition prepared by mixing 25 parts by weight of the compound represented by Formula 1-11, 45 parts by weight of TBP-102 (refractive index: 1.553, Hannong Chemical Co., Ltd.), 24 parts by weight of HRI-84 (refractive index: 1.602, Daerim Chemical Co., Ltd.), 3 parts by weight of PN662NT (refractive index: 1.503, Miwon Special Chemical Co., Ltd.) as a crosslinking agent, and 3 parts by weight of TPO (refractive index: 1.6, BASF AG) as an initiator was coated onto one surface of a transparent PET (polyethylene terephthalate) base film (T910E, thickness: 75 μm, Mitsubishi), cured at 350 mJ/cm² and then subjected to ball drop testing, which yielded a drop height of 10 cm.

### Example 12

### Preparation of Acrylic Compound Represented by Formula 1-12

A diluted solution was obtained by diluting 25.04 g (200 mmol) of 4-aminobenzenethiol in 400 mL of tetrahydrofuran (THF) and cooling the solution in an ice bath. Then, 21.3 g (210 mmol) of trimethylamine was added to the resultant solution. With the resultant solution kept at 0° C., a diluted solution prepared by diluting 21.1 g (100 mmol) of phenylthiophosphonic dichloride in 200 mL of THF was slowly added to the resultant solution using a dropping funnel. After removing the ice bath, the reactants were filtered and stirred for about 2 hours. After completion of the reaction, the resultant solution was filtered to remove amine salts. The filtered organic solution was cooled to 0° C. and 21.3 g (210 mmol) of trimethylamine was added thereto. Then, a diluted solution prepared by diluting 18.6 g (205 mmol) of acryloyl chloride in 100 mL of THF was slowly added to the resultant solution, which in turn was stirred for 1 hour. After completion of the reaction, the reacting solution was filtered to remove amine salts, followed by distillation under reduced pressure to remove excess solvent. To the concentrated organic material, 500 mL of CH₂Cl₂ was added, followed by washing with aq. 5% HCl/aq. 5% NaOH. The organic layer was extracted with CH₂Cl₂, dried with MgSO₄, and filtered to prepare an organic solution layer. Then, 21.3 g (210 mmol) of triethylamine was added to the organic solution layer, which in turn was cooled to 0° C. To the cooled reactants, 15.62 g (200 mmol) of mercaptoethanol was slowly added dropwise, and reacted at room temperature for 2 hours. After completion of the reaction, the reaction product was washed with aq. 5% NaOH/aq. 5% NaCl, and the organic layer was extracted with CH₂Cl₂, dried with MgSO₄, and filtered to prepare an organic solution layer. To the organic solution layer, 21.3 g (210 mmol) of triethylamine was added and cooled again to 0° C. To the cooled reactants, a diluted solution prepared by diluting 18.1 g (200 mmol) of acryloyl chloride in 100 mL of CH₂Cl₂ was slowly added and stirred for 1 hour. After completion of the reaction, the reaction product was washed with aq. 5% HCl/aq. 5% NaOH, and the organic layer was extracted with CH₂Cl₂, dried with MgSO₄ and distilled under reduced pressure to prepare the final product {Pale yellow sticky oil, yield: 78%, refractive index (RI)=1.631}. ¹H-NMR (300 MHz, CDCl₃): δ 8.23 (br, 2H), 7.98-7.95 (m, 2H), 7.53-7.44 (m, 4H), 7.34-7.25 (m, 4H), 6.41 (dd, J=0.9, 10.2 Hz, 2H), 6.23 (dd, J=6.0, 9.9 Hz, 2H), 5.84 (dd, J=0.6, 6.0 Hz, 2H), 4.31 (t, J=5.2 Hz, 4H), 2.89-2.72 (m, 8H), 2.63 (t, J=7.0 Hz, 4H).

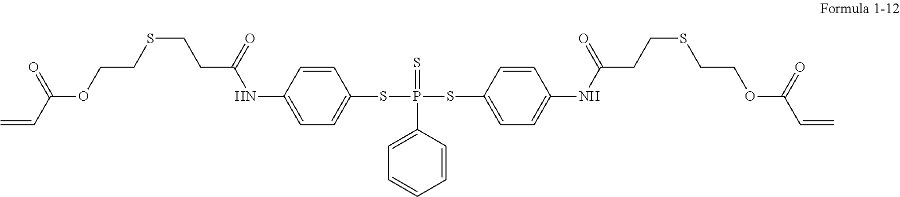 [SMILES: C=CC(=O)OCCSCCC(=O)Nc1ccc(SP(=S)(Sc2ccc(NC(=O)CCSCCOC(=O)C=C)cc2)c2ccccc2)cc1]

A composition prepared by mixing 25 parts by weight of the compound represented by Formula 1-12, 45 parts by weight of TBP-102 (refractive index: 1.553, Hannong Chemical Co., Ltd.), 24 parts by weight of HRI-84 (refractive index: 1.602, Daerim Chemical Co., Ltd.), 3 parts by weight of PN662NT (refractive index: 1.503, Miwon Special Chemical Co., Ltd.) as a crosslinking agent, and 3 parts by weight of TPO (refractive index: 1.6, BASF AG) as an initiator was coated onto one surface of a transparent PET (polyethylene terephthalate) base film (T910E, thickness: 75 μm, Mitsubishi), cured at 350 mJ/cm² and then subjected to ball drop testing, which yielded a drop height of 12 cm.

### Example 13

### Preparation of Acrylic Compound Represented by Formula 1-13

A diluted solution was obtained by diluting 3.4 g (20 mmol) of 4-((2-hydroxyethyl)thio)phenol in 50 mL of tetrahydrofuran (THF) and cooling the solution in an ice bath. Then, 2.3 g (20.5 mmol) of potassium t-butoxide (K^{t}OBu) was added to the resultant solution. With the resultant solution kept at 0° C., a diluted solution prepared by diluting 2.11 g (10 mmol) of phenylthiophosphonic dichloride in 10 mL of THF was slowly added to the resultant solution using a dropping funnel. After removing the ice bath, the reactants were stirred for 3 hours. After completion of the reaction, the reaction product was washed with aq. 5% HCl/aq. 5% NaOH, and the organic layer was extracted with CH₂Cl₂, dried with MgSO₄, and filtered to prepare an organic solution layer. Then, 2.13 g (21 mmol) of triethylamine was added to the organic solution layer, which in turn was cooled to 0° C. Then, a diluted solution prepared by diluting 1.86 g (20.5 mmol) of acryloyl chloride in 10 mL of CH₂Cl₂ was slowly added to the reactant solution, which in turn was stirred for 1 hour. After completion of the reaction, the reaction product was washed with 5% HCl/aq. 5% NaOH, and the organic layer was extracted with CH₂Cl₂, dried with MgSO₄ and distilled under reduced pressure to prepare the final product {Pale yellow sticky oil, yield: 86%, refractive index (RI)=1.620}. ¹H-NMR (300 MHz, CDCl₃): δ 8.18-8.01 (m, 2H), 7.57-7.52 (m, 3H), 7.37-7.32 (m, 4H), 7.07-7.01 (m, 4), 6.36 (dd, J=1.4, 17.2 Hz, 2H), 6.06 (dd, J=10.4, 17.2 Hz, 2H), 5.82 (dd, J=1.5, 10.4, Hz, 2H), 4.30 (t, J=6.9 Hz, 4H), 3.13 (t, J=6.9 Hz, 4H).

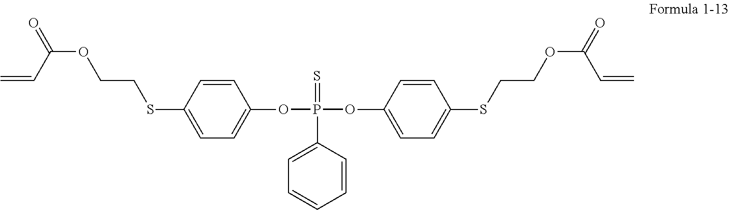 [SMILES: C=CC(=O)OCCSc1ccc(OP(=S)(Oc2ccc(SCCOC(=O)C=C)cc2)c2ccccc2)cc1]

A composition prepared by mixing 25 parts by weight of the compound represented by Formula 1-13, 45 parts by weight of TBP-102 (refractive index: 1.553, Hannong Chemical Co., Ltd.), 24 parts by weight of HRI-84 (refractive index: 1.602, Daerim Chemical Co., Ltd.), 3 parts by weight of PN662NT (refractive index: 1.503, Miwon Special Chemical Co., Ltd.) as a crosslinking agent and 3 parts by weight of TPO (refractive index: 1.6, BASF AG) as an initiator was coated onto one surface of a transparent PET (polyethylene terephthalate) base film (T910E, thickness: 75 μm, Mitsubishi), cured at 350 mJ/cm² and then subjected to ball drop testing, which yielded a drop height of 12 cm.

### Example 14

### Preparation of Acrylic Compound Represented by Formula 1-14

4-hydroxyphenyl phenyl phenylphosphonotrithioate (200 mmol scale) obtained according to Preparative Example 2 was diluted in 300 mL of methylethylketone (MEK). To the resultant solution, 21.93 g (140 mmol) of [4-(chloromethyl)phenyl]methanol, 55 g (400 mmol) of potassium carbonate and 3 g (20 mmol) of NaI were added, followed by stirring at 80° C. for 8 hours. After completion of the reaction, the remaining potassium salt was removed, and the resultant solution was subjected to reduced pressure to remove excess solvent and then washed with aq. 5% HCl/aq. 5% NaOH. The organic layer was extracted with CH₂Cl₂, dried with MgSO₄, and filtered to prepare an organic solution layer. Then, 20.74 g (205 mmol) of triethylamine was added to the filtered organic solution layer, which in turn was cooled again to 0° C. To the reactants, a diluted solution prepared by diluting 18.1 g (200 mmol) of acryloyl chloride in 10 mL of CH₂Cl₂ was slowly added, followed by stirring for 1 hour. After completion of the reaction, the reaction product was washed with 5% HCl/aq. 5% NaOH, and the organic layer was extracted with CH₂Cl₂, dried with MgSO₄ and distilled under reduced pressure to prepare the final product {Pale yellow sticky oil, yield: 76%, refractive index (RI)=1.663}. ¹H-NMR (300 MHz, CDCl₃): δ 7.98-7.90 (m, 2H), 7.52-7.22 (m, 14H), 6.86 (d, J=8.7 Hz, 2H), 6.44 (dd, J=1.5, 17.1 Hz, 1H), 6.15 (dd, J=10.5, 17.4 Hz, 1H), 5.84 (dd, J=1.5, 10.5 Hz, 1H), 5.20 (s, 2H), 5.02 (s, 2H).

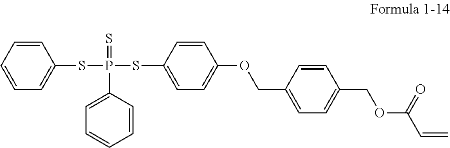 [SMILES: C=CC(=O)OCc1ccc(COc2ccc(SP(=S)(Sc3ccccc3)c3ccccc3)cc2)cc1]

A composition prepared by mixing 25 parts by weight of the compound represented by Formula 1-14, 45 parts by weight of TBP-102 (refractive index: 1.553, Hannong Chemical Co., Ltd.), 24 parts by weight of HRI-84 (refractive index: 1.602, Daerim Chemical Co., Ltd.), 3 parts by weight of PN662NT (manufactured by Miwon Special Chemical Co., Ltd., refractive index: 1.503) as a crosslinking agent, and 3 parts by weight of TPO (refractive index: 1.6, BASF AG) as an initiator was coated onto one surface of a transparent PET (polyethylene terephthalate) base film (T910E, thickness: 75 μm, Mitsubishi), cured at 350 mJ/cm² and then subjected to ball drop testing, which yielded a drop height of 10 cm.

### Property Evaluation

### (1) Measurement of Refractive Index

1) When the prepared acrylic compound had a liquid phase, the organic solvent was completely removed from the compound. Thereafter, the compound was applied to a surface of a refractometer (3T manufactured by ATAGO ABBE in Japan; light source: D light sodium lamp of 589.3 mm) to measure the refractive index.

2) When the prepared acrylic compound had a solid phase, the compound was diluted in a solvent DMSO (dimethyl sulfoxide) (refractive index: 1.479) capable of dissolving the solid, and then applied to the surface of the refractometer (3T manufactured by ATAGO ABBE in Japan; light source: D light sodium lamp of 589.3 mm) to measure the refractive index.

### (2) Ball Drop Testing:

A composition was coated onto one surface of a transparent PET (polyethylene terephthalate) base film (T910E, thickness: 75 μm, Mitsubishi), and cured at 350 mJ/cm². Ball drop testing provided data of the drop heights at which breakage started to occur when a ball weighing 36 g (SUS, a spherical shape) was dropped from a height starting at 1 cm and increasing incrementally. A higher drop height value indicates better elasticity and impact resistance of the optical sheet.

From the evaluation results, it can be seen that the acrylic compounds according to embodiments of the present invention had high refractive indices of 1.65 or greater despite the lack of halogen atoms. In addition, it can be seen that the optical sheets of Examples 10 to 14 not only had a refractive index of 1.65 or greater, but also exhibited good ball drop test results.

While certain exemplary embodiments of the present invention have been illustrated and described, it is understood that various modifications, changes, alterations, and equivalent embodiments can be made by those skilled in the art without departing from the spirit and scope of the present invention, as defined in the following claims.

What is claimed is:

1. An acrylic compound represented by Formula 1: 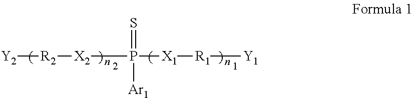
Wherein:
R₁ and R₂ are each independently a C₂ to C₁₀ alkylene group, a C₆ to C₂₀ arylene group, a C₇ to C₂₀ alkylarylene group, or a C₇ to C₂₀ arylalkylene group;
Ar₁ is a C₆ to C₁₀ aryl group;
X₁ and X₂ are each independently —O— or —S—;
Y₁ and Y₂ are each independently a hydrogen atom, —OH, —SH, —NH₂, 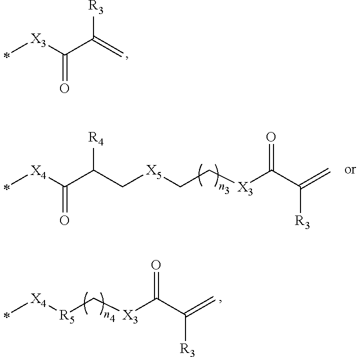
wherein:
R₃ and R₄ are each independently a hydrogen atom or a methyl group, R₅ being a C₁ to C₁₀ alkylene group, a C₆ to C₂₀ arylene group, a C₆ to C₂₀ arylalkylene group or a C₆ to C₂₀ alkylarylene group,
X₃, X₄, and X₅ are each independently —O—, —S— or —N(R)— wherein R is a hydrogen atom or an alkyl group, and
* indicates a binding site:
at least one of Y₁ and Y₂ is 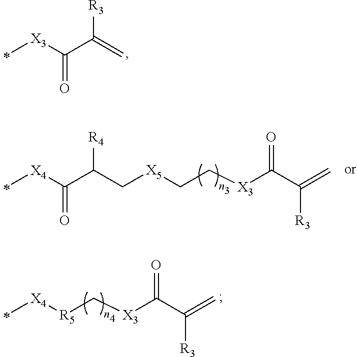
and
n₁, n₂, n₃ and n₄ are each independently 1 to 4 on average.

2. The acrylic compound according to claim 1, wherein the acrylic compound comprises at least one compound selected from the group consisting of compounds represented by Formulae 1a to 1j.

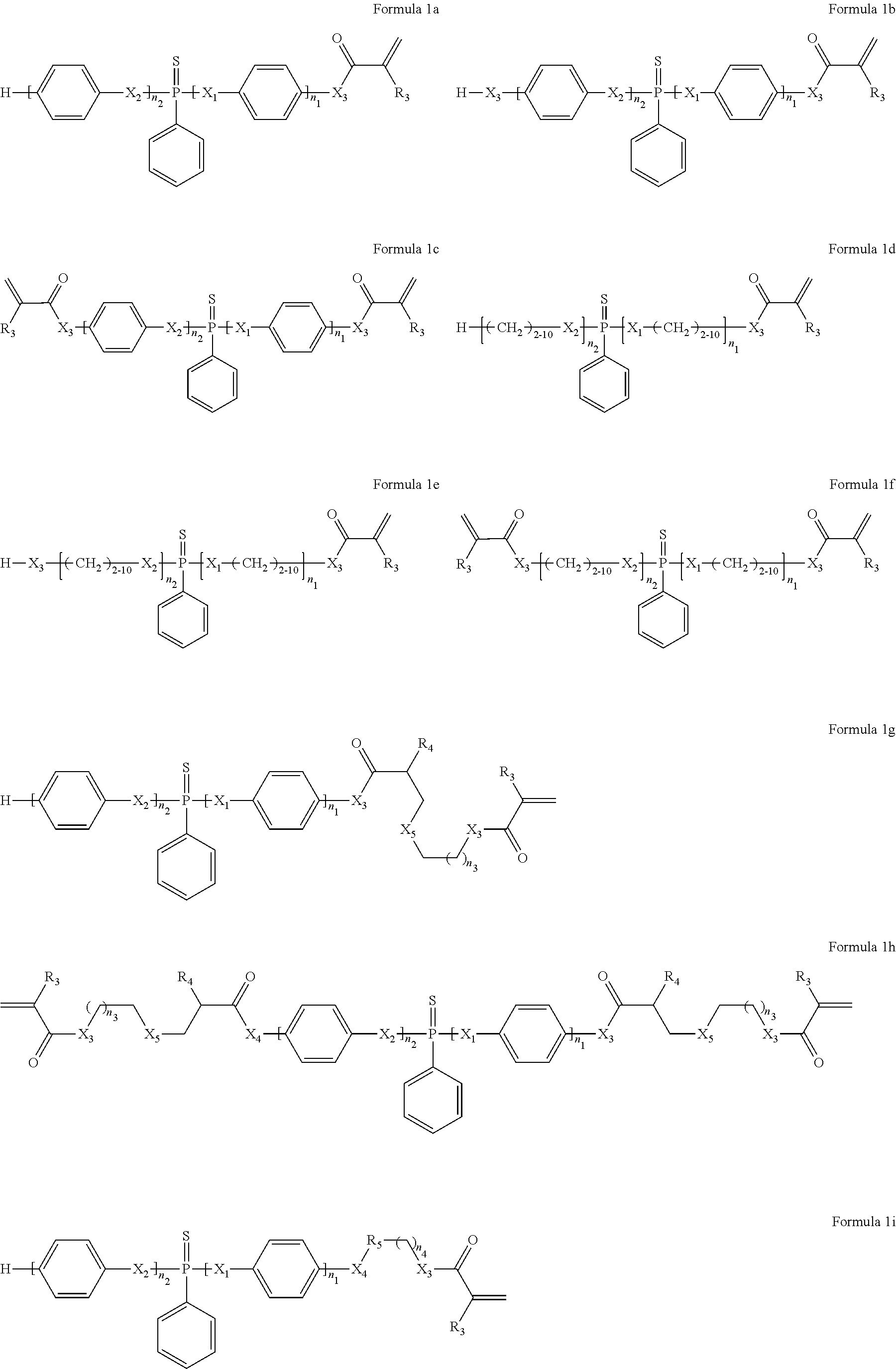

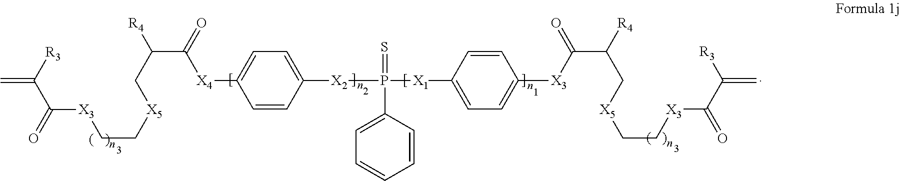

3. The acrylic compound according to claim 1, wherein the acrylic compound has a refractive index of about 1.65 to about 1.75.

4. A composition for optical patterns, comprising:
the acrylic compound according to claim 1;
an initiator; and
at least one of a non-phosphorus monomer and a monomer comprising an alkylene oxide unit represented by Formula 7:
*R₁₅—Oₙ* Formula 7
wherein * indicates a binding site, R₁₅ is a C₁ to C₅ alkylene group, and n is an integer of 1 to 10.

5. The composition for optical patterns according to claim 4, further comprising a crosslinking agent.

6. The composition for optical patterns according to claim 4, wherein the monomer comprising the alkylene oxide unit of Formula 7 comprises a monomer represented by Formula 8: 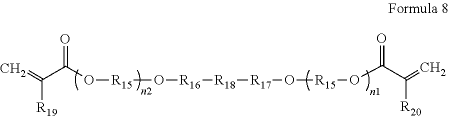
wherein:
R₁₆ and R₁₇ are each independently a C₆ to C₁₀ arylene group, a C₇ to C₂₀ alkylarylene group, or a C₇ to C₂₀ arylalkylene group;
R₁₈ is a single bond, a C₁ to C₅ alkylene group, —S—, —O—, or —NR, wherein R is a hydrogen atom or a C₁ to C₅ alkyl group;
R₁₉ and R₂₀ are each independently hydrogen or a methyl group; and
n₁ and n₂ are each independently an integer of 1 to 10.

7. The composition for optical patterns according to claim 4, wherein the non-phosphorus monomer comprises a mono-functional (meth)acrylic monomer comprising a moiety represented by Formula 6a or Formula 6b, or a bi-functional (meth)acrylic monomer comprising a moiety represented by Formula 6a or Formula 6b, or a mixture thereof:
R₁₁—S—R₁₂—* Formula 6a
wherein:
* indicates a binding site;
R₁₁ is a hydrogen atom, a C₁ to C₁₀ alkyl group, a C₆ to C₁₀ aryl group, or a C₇ to C₁₀ arylalkyl group; and
R₁₂ is a C₁ to C₁₀ alkylene group, a C₆ to C₁₀ arylene group, or a C₇ to C₁₀ arylalkylene group;
*—R₁₃—S—R₁₄—* Formula 6b
wherein:
* indicates a binding site; and
R₁₃ and R₁₄ are each independently a C₁ to C₁₀ alkylene group, a C₆ to C₁₀ arylene group, or a C₇ to C₁₀ arylalkylene group.

8. The composition for optical patterns according to claim 5, wherein the crosslinking agent comprises a (meth)acrylic monomer comprising three or more functional groups and an aromatic group.

9. The composition for optical patterns according to claim 4, wherein the composition after cure has a drop height of 6 cm or greater at which breakage of the composition begins, as measured in ball drop testing using a ball weighing 36 g.

10. A method for preparing an acrylic compound represented by Formula 1, the method comprising:
reacting a sulfur-containing phosphorus compound represented by Formula 2 with an acryloyl halide compound represented by Formula 3: 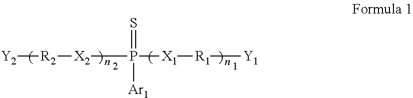
wherein:
R₁ and R₂ are each independently a C₂ to C₁₀ alkylene group, a C₆ to C₂₀ arylene group, a C₇ to C₂₀ alkylarylene group, or a C₇ to C₂₀ arylalkylene group;
Ar₁ is a C₆ to C₁₀ aryl group;
X₁ and X₂ are each independently —O— or —S—;
Y₁ and Y₂ are each independently a hydrogen atom, —OH, —SH, —NH₂, 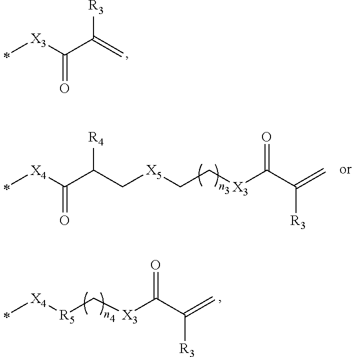
wherein:
R₃ and R₄ are each independently a hydrogen atom or a methyl group,
R₅ is a C₁ to C₁₀ alkylene group, a C₆ to C₂₀ arylene group, a C₆ to C₂₀ arylalkylene group or a C₆ to C₂₀ alkylarylene group,
X₃, X₄ and X₅ is —O—, —S— or —N(R)—, wherein R is a hydrogen atom or an alkyl group, and
* indicating a binding site);
at least one of Y₁ and Y₂ is 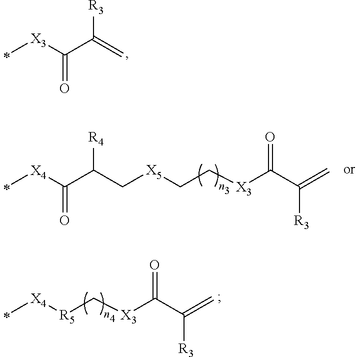
and
n₁, n₂, n₃ and n₄ are each independently 1 to 4 on average; 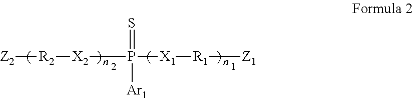
wherein:
Z₁ and Z₂ are each independently a hydrogen atom, —OH, —SH, —NH₂, 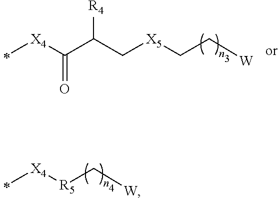
wherein W is —OH, —SH or —NH₂); and
at least one of Z₁ and Z₂ is —OH, —SH, —NH₂, 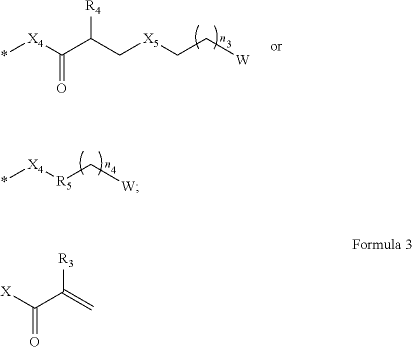
wherein R₃ is a hydrogen atom or a methyl group, and X is a halogen atom.

11. The method for preparing an acrylic compound according to claim 10, wherein the reaction is performed at a temperature of about −10° C. to about 10° C. in the presence of a basic catalyst.

12. The method for preparing an acrylic compound according to claim 11, wherein the basic catalyst comprises at least one selected from the group consisting of triethylamine, diisopropylamine, tetramethylethylenediamine, pyridine, sodium hydroxide, potassium hydroxide, potassium carbonate, dibutyltin dilaurate, and amine complex compounds.

13. The method for preparing an acrylic compound according to claim 10, wherein the reaction is performed in the presence of a solvent, the solvent comprising at least one selected from the group consisting of tetrahydrofuran, chloroform, dichloromethane, N-methylpyrrolidone, dimethylsulfoxide, N,N-dimethylacetamide, dioxane, alcohol, benzene, dimethoxyethane, acetonitrile, and water.

14. The method for preparing an acrylic compound according to claim 10, wherein the sulfur-containing phosphorus compound is prepared by reacting a compound represented by Formula 4 with a compound represented by Formula 5a and a compound represented by Formula 5b: 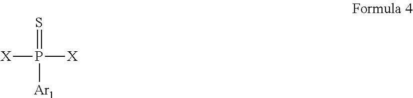
wherein X is a halogen atom; 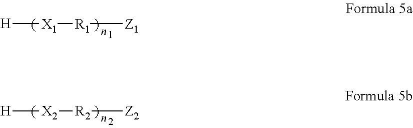
wherein:
Z₁ and Z₂ are each independently a hydrogen atom, —OH, —SH, —NH₂, 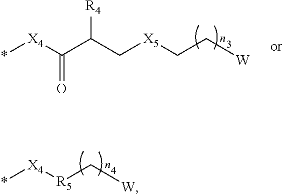
wherein W is —OH, —SH or —NH₂); and
at least one of Z₁ and Z₉ is —OH, —SH, —NH₂,

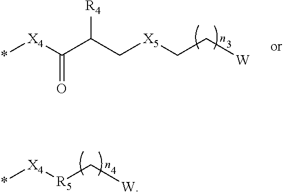

15. The method for preparing an acrylic compound according to claim 10, wherein the sulfur-containing phosphorus compound is prepared by reacting a compound represented by Formula 4 with a compound represented by Formula 5c and a compound represented by Formula 5d, followed by reaction with a compound represented by Formula 9, and then reacting with a compound represented by Formula 10: 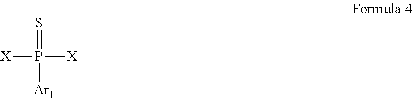
wherein X is a halogen atom; 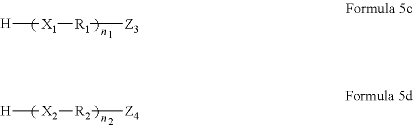
wherein Z₃ and Z₄ are each independently a hydrogen atom, —OH, —SH or —NH₂;
and at least one of Z₃ and Z₄ is —OH, —SH, or —NH₂; 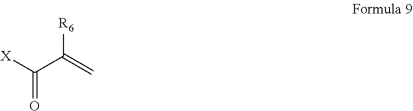
wherein R₆ is a hydrogen atom or a methyl group, and X is a halogen atom; 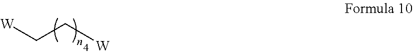
wherein W is —OH, —SH or —NH₂, and n₄ is 1 to 4 on average.

16. The method for preparing an acrylic compound according to claim 10, wherein the sulfur-containing phosphorus compound is prepared by reacting a compound represented by Formula 4 with a compound represented by Formula 5c and a compound represented by Formula 5d, followed by reaction with a compound represented by Formula 11: 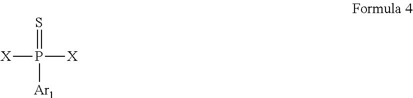
wherein X is a halogen atom; 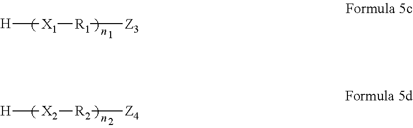
wherein Z₃ and Z₄ are each independently a hydrogen atom, —OH, —SH or —NH₂;
and at least one of Z₃ and Z₄ is —OH, —SH, or —NH₂; 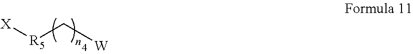
wherein:
W is —OH, —SH or —NH₂;
R₅ is a C₁ to C₁₀ alkylene group, a C₆ to C₂₀ arylene group, a C₆ to C₂₀ arylalkylene group or a C₆ to C₂₀ alkylarylene group;
X is a halogen atom; and
n₄ is 1 to 4 on average.

17. An optical sheet, comprising:
a base layer; and
an optical pattern layer formed on a surface of the base layer,
wherein the optical pattern layer comprises the composition for optical patterns according to claim 4.
